(19) United States
(12) Patent Application Publication
(10) Pub. No.: US 2023/0418305 A1
(43) Pub. Date: Dec. 28, 2023

(54) INTEGRATED NAVIGATION CALLBACKS FOR A ROBOT

(71) Applicant: Boston Dynamics, Inc., Waltham, MA (US)

(72) Inventors: Joel Chestnutt, Waltham, MA (US); Rick Shanor, Waltham, MA (US)

(73) Assignee: Boston Dynamics, Inc., Waltham, MA (US)

(21) Appl. No.: 18/338,881

(22) Filed: Jun. 21, 2023

Related U.S. Application Data
(60) Provisional application No. 63/354,773, filed on Jun. 23, 2022.

(51) Int. Cl. G05D 1/02

(52) U.S. Cl. CPC G05D 1/0274; G05D 1/0212; G05D 2201/0217

(57) ABSTRACT

One disclosed method involves at least one application controlling navigation of a robot through an environment based at least in part on a topological map, the topological map including at least a first waypoint, a second waypoint, and a first edge representing a first path between the first waypoint and the second waypoint. The at least one application determines that the topological map includes at least one feature that identifies a first service that is configured to control the robot to perform at least one operation, and instructs the first service to perform the at least one operation as the robot travels along at least a portion of the first path.

### RELATED APPLICATIONS

This application claims the benefit under 35 U.S.C. § 119(e) of U.S. Provisional Patent Application Ser. No. 63/354,773, filed Jun. 23, 2022, and entitled, “INTEGRATED NAVIGATION CALLBACKS FOR A ROBOT,” the entire contents of which is incorporated herein by reference.

### BACKGROUND

A robot is generally a reprogrammable and multifunctional manipulator, often designed to move material, parts, tools, or specialized devices through variable programmed motions for performance of tasks. Robots may be manipulators that are physically anchored (e.g., industrial robotic arms), mobile robots that move throughout an environment (e.g., using legs, wheels, or traction-based mechanisms), or some combination of a manipulator and a mobile robot. Robots are utilized in a variety of industries including, for example, manufacturing, warehouse logistics, transportation, hazardous environments, exploration, and healthcare.

### SUMMARY

In some disclosed embodiments, a mobile robot includes a robot body; one or more locomotion based structures, coupled to the body, the one or more locomotion based structures being configured to move the mobile robot about an environment; at least one first processor; and at least one first computer-readable medium encoded with instructions which, when executed by the at least one first processor, cause the mobile robot to control, by at least one application and based at least in part on a topological map, navigation of the mobile robot through the environment, the topological map including at least a first waypoint, a second waypoint, and a first edge representing a first path between the first waypoint and the second waypoint, to determine, by the at least one application, that the topological map includes at least one feature that identifies a first service, the first service configured to control the mobile robot to perform at least one operation, and to instruct, by the at least one application and based at least in part on the topological map including the at least one feature, the first service to perform the at least one operation as the mobile robot travels along at least a portion of the first path.

In some embodiments, a robot controller includes at least one processor, and at least one computer-readable medium encoded with instructions which, when executed by the at least one processor, cause the robot controller to receive, by a user interface associated with the mobile robot, one or more inputs instructing the mobile robot to perform at least one operation when the mobile robot travels within a designated portion of the environment, and to issue one or more instructions to include at least one feature in a topological map to be used by at least one application to control navigation of the mobile robot within the environment, the topological map including at least a first waypoint, a second waypoint, and a first edge representing a first path between the first waypoint and the second waypoint, wherein the at least one feature is configured to direct the at least one application to instruct a first service to control the mobile robot to perform the at least one operation as the mobile robot travels along at least a portion of the first path.

In some embodiments, a method involves controlling, by at least one application and based at least in part on a topological map, navigation of a robot through an environment, the topological map including at least a first waypoint, a second waypoint, and a first edge representing a first path between the first waypoint and the second waypoint; determining, by the at least one application, that the topological map includes at least one feature that identifies a first service, the first service configured to control the robot to perform at least one operation; and instructing, by the at least one application and based at least in part on the topological map including the at least one feature, the first service to perform the at least one operation as the robot travels along at least a portion of the first path.

In some embodiments, a method involves receiving, by a user interface associated with a robot, one or more inputs instructing the robot to perform at least one operation when the robot travels within a designated portion of an environment; and issuing one or more instructions to include at least one feature in a topological map to be used by at least one application to control navigation of the robot within the environment, the topological map including at least a first waypoint, a second waypoint, and a first edge representing a first path between the first waypoint and the second waypoint, wherein the at least one feature is configured to direct the at least one application to instruct a first service to control the robot to perform the at least one operation as the robot travels along at least a portion of the first path.

In some embodiments, a system includes at least one processor, and at least one computer-readable medium encoded with instructions which, when executed by the at least one processor, cause the system to control, by at least one application and based at least in part on a topological map, navigation of a robot through an environment, the topological map including at least a first waypoint, a second waypoint, and a first edge representing a first path between the first waypoint and the second waypoint, to determine, by the at least one application, that the topological map includes at least one feature that identifies a first service, the first service configured to control the robot to perform at least one operation, and to instruct, by the at least one application and based at least in part on the topological map including the at least one feature, the first service to perform the at least one operation as the robot travels along at least a portion of the first path.

In some embodiments, a system includes at least one processor, and at least one computer-readable medium encoded with instructions which, when executed by the at least one processor, cause the system to receive, by a user interface associated with a robot, one or more inputs instructing the robot to perform at least one operation when the robot travels within a designated portion of an environment, and to issue one or more instructions to include at least one feature in a topological map to be used by at least one application to control navigation of the robot within the environment, the topological map including at least a first waypoint, a second waypoint, and a first edge representing a first path between the first waypoint and the second waypoint, wherein the at least one feature is configured to direct the at least one application to instruct a first service to control the robot to perform the at least one operation as the robot travels along at least a portion of the first path.

In some embodiments, at least one non-transitory computer-readable medium is encoded with instructions which, when executed by the at least one processor included in a system, cause the system to control, by at least one application and based at least in part on a topological map, navigation of a robot through an environment, the topological map including at least a first waypoint, a second waypoint, and a first edge representing a first path between the first waypoint and the second waypoint, to determine, by the at least one application, that the topological map includes at least one feature that identifies a first service, the first service configured to control the robot to perform at least one operation, and to instruct, by the at least one application and based at least in part on the topological map including the at least one feature, the first service to perform the at least one operation as the robot travels along at least a portion of the first path.

In some embodiments, at least one non-transitory computer-readable medium is encoded with instructions which, when executed by the at least one processor included in a system, cause the system to receive, by a user interface associated with a robot, one or more inputs instructing the robot to perform at least one operation when the robot travels within a designated portion of an environment, and to issue one or more instructions to include at least one feature in a topological map to be used by at least one application to control navigation of the robot within the environment, the topological map including at least a first waypoint, a second waypoint, and a first edge representing a first path between the first waypoint and the second waypoint, wherein the at least one feature is configured to direct the at least one application to instruct a first service to control the robot to perform the at least one operation as the robot travels along at least a portion of the first path.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1A illustrates an example of a legged robot configured to navigate in an environment along a route, in accordance with some embodiments;

FIG. 1B is a block diagram of components of a robot, such as the robot shown in FIG. 1A;

FIG. 2 illustrates components of a navigation system used to navigate a robot, such as the robot of FIG. 1A in an environment, in accordance with some embodiments;

FIG. 3 illustrates an example user interface screen of a robot controller that may be used to control operations of a robot, such as the robot of FIG. 1A, in accordance with some embodiments;

FIG. 4 shows a first example scenario in which an operator may, while recording a mission for a robot, such as the robot of FIG. 1A, create an action using a navigation callback service, in accordance with some embodiments;

FIG. 5 shows a second example scenario in which an operator may, while recording a mission for a robot, such as the robot of FIG. 1A, create an action using a navigation callback service, in accordance with some embodiments;

FIG. 6 shows a first example routine that may be executed by a robot, such as the robot of FIG. 1A, in accordance with some embodiments;

FIG. 7 shows a first example routine that may be executed by a robot controller, in accordance with some embodiments; and

FIG. 8 illustrates an example configuration of a robotic device, according to some embodiments.

### DETAILED DESCRIPTION

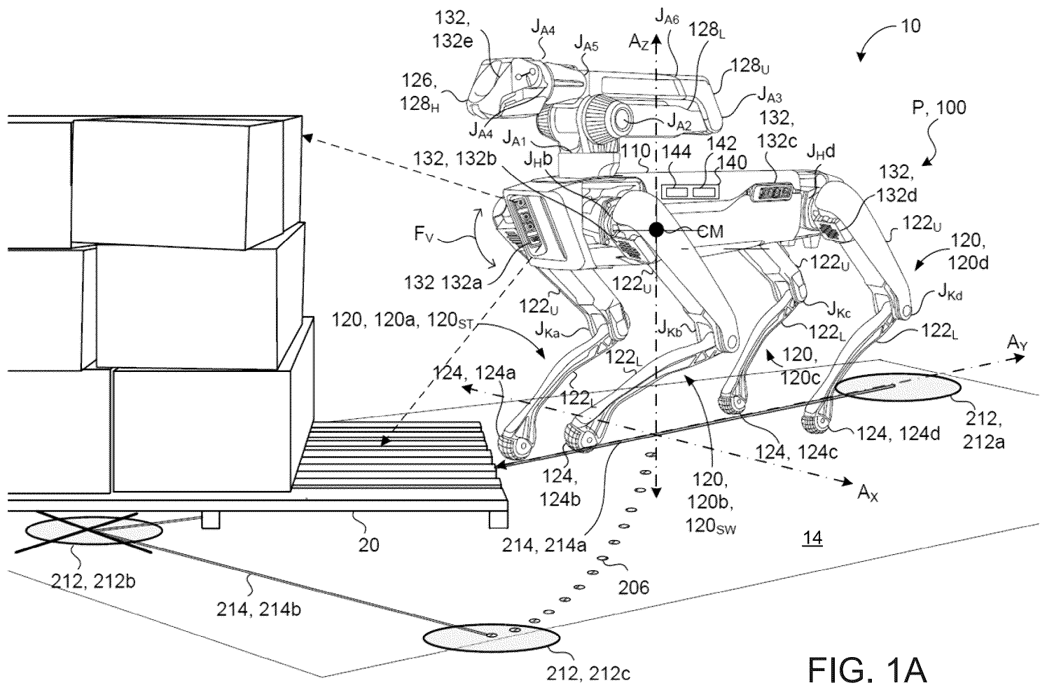

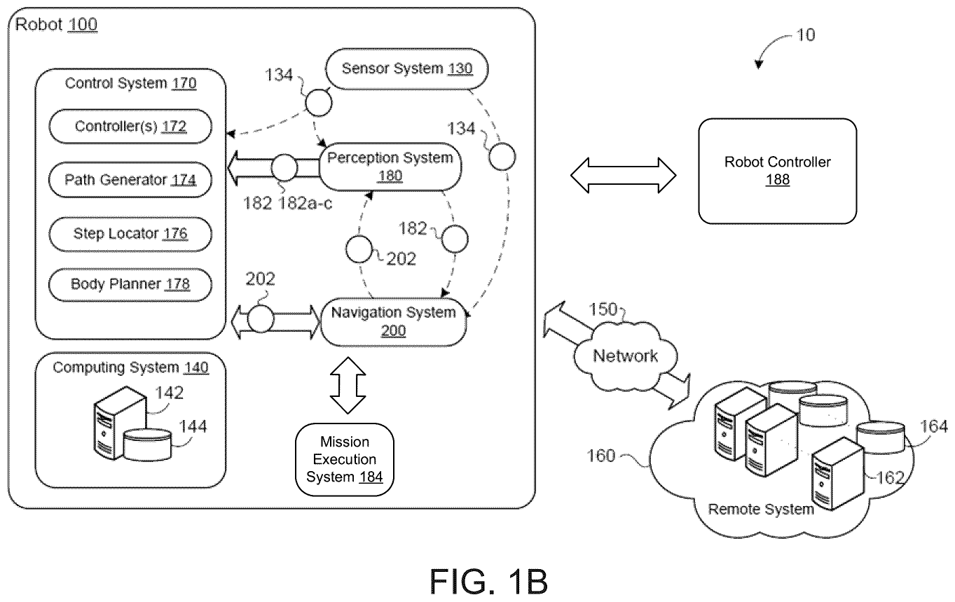

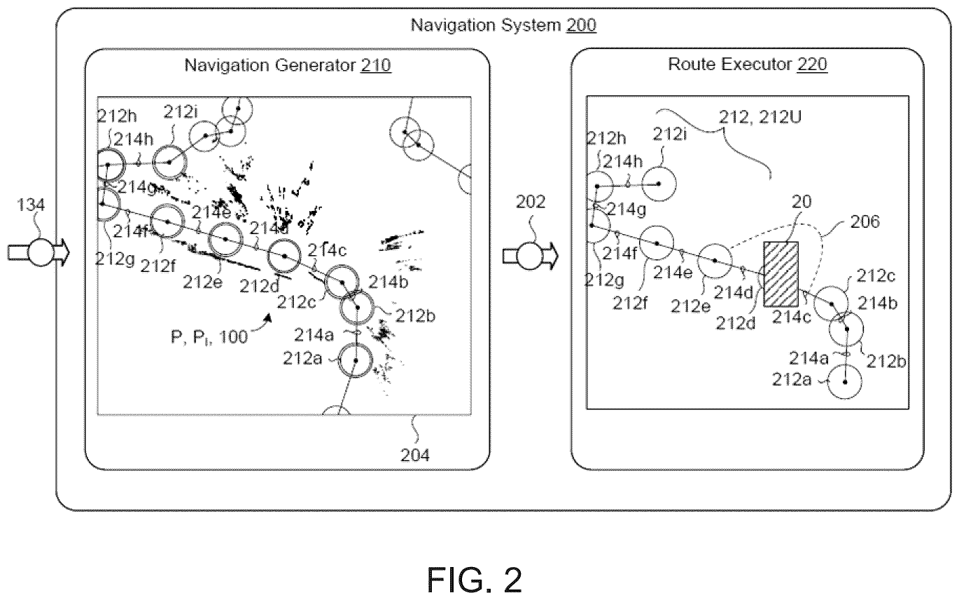

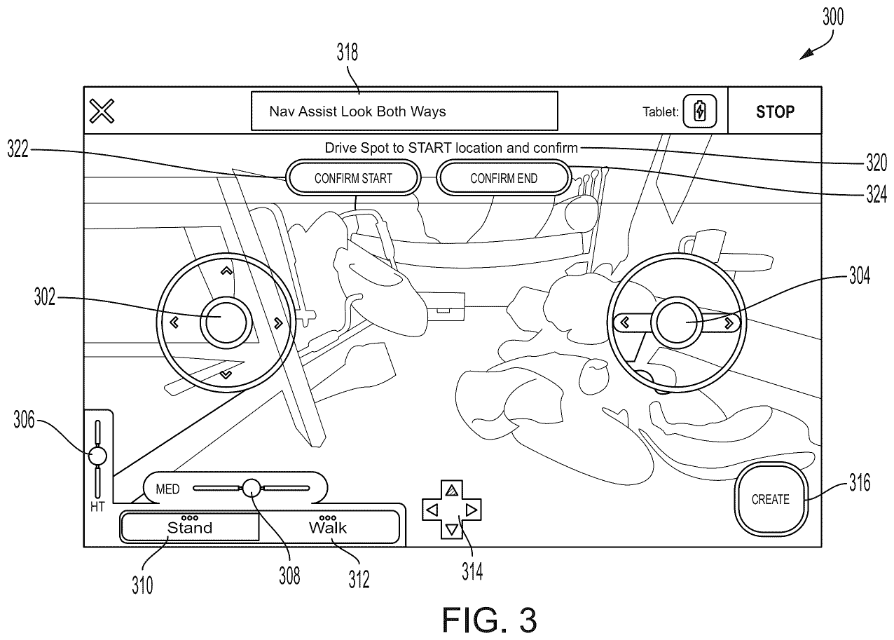

A robot may be configured to execute “missions” to accomplish particular objectives, such as performing surveillance, collecting sensor data, etc. An example of a robot 100 that is capable of performing such missions is described below in connection with FIGS. 1A-B. To enable the robot 100 to execute a mission, the robot 100 may undergo an initial mapping process during which the robot 100 moves about an environment 10 (e.g., in response to commands input by a user to a tablet or other controller—an example of which is shown in FIG. 3) to gather data (e.g., via one or more sensors) about the environment 10 and may generate a topological map 204 (an example of which is shown in FIG. 2) that defines waypoints 212 of the robot 100 as well as edges 214 representing paths between respective pairs of such waypoints 212. Individual waypoints 212 may, for example, represent sensor data, fiducials, and/or robot pose information at specific times and places, whereas individual edges 214 may connect waypoints 212 topologically.

In some existing systems, a given “mission recording” may identify a sequence of actions that are to take place at particular waypoints 212 included on a topological map 204. For instance, a mission recording may indicate that the robot 100 is to go to a first waypoint 212 and perform a first action, then go to a second waypoint 212 and perform a second action, etc. In some implementations, such a mission recording need not specify all of the waypoints 212 the robot 100 will actually traverse when the mission is executed, and may instead specify only those waypoints 212 at which particular actions are to be performed. As explained in detail below, such a mission recording may be executed by a mission execution system 184 (shown in FIG. 1B) of the robot 100. The mission execution system 184 may make function calls to other systems of the robot 100, as needed, to execute the mission successfully. For instance, in some implementations, the mission execution system 184 may make a call to a navigation system 200 (also shown in FIG. 1B) requesting that the navigation system 200 determine, using the topological map 204 and the mission recording, a navigation route 202 that includes the various waypoints 212 of the topological map 204 that are identified in the mission recording, as well as any number of additional waypoints 212 of the topological map 204 that are located between the waypoints 212 that are identified in the mission recording. The determined navigation route 202 may likewise include the edges 214 that are located between respective pairs of such waypoints 212. Causing the robot to follow a navigation route 202 that includes all of the waypoints 212 identified in the mission recording may enable the mission execution system 184 to perform the corresponding actions in the mission recording when the robot 100 reaches those waypoints 212.

As described below with reference to FIG. 2, the navigation system 200 may include a navigation generator 210 that can generate a navigation route 202 that includes specified waypoints 212 (e.g., the waypoints 212 identified in a mission recording), as well as a route executor 220 that can control the robot 100 to move along the identified navigation route 202, possibly re-routing the robot along an alternative path 206, e.g., if needed to avoid an unforeseen obstacle 20.

As noted above, in some existing systems, a mission recording may identify particular actions the robot 100 is to take when it reaches specific waypoints 212. For instance, with reference to the right-hand side of FIG. 2, a mission recording may specify that the robot 100 is to begin flashing a light to warn others of its presence when it reaches a first waypoint 212d, and is to cease flashing the light when it reaches a second waypoint 212e. In such case, when the mission execution system 184 determines that the robot 100 has reached the first waypoint 212d, the mission execution system 184 may instruct a system of the robot to begin flashing the light. Similarly, when the mission execution system 184 determines that the robot 100 has reached the second waypoint 212e, the mission execution system 184 may instruct that same system of the robot to cease flashing the light.

Although defining waypoint-specific actions in a mission recording, as described above, is effective in some circumstances, situations can arise in which the robot 100 never reaches one of the waypoints 212 at which it is supposed to perform a particular action, e.g., to begin flashing a warning light at the waypoint 212d. For instance, if one of the waypoints 212 identified in the mission recording (e.g., the waypoint 212d shown in FIG. 2) cannot be reached due to the presence of an obstacle 20 that was not present during mission recording, then the route executor 220 of the navigation system 200 may re-route the robot 100, e.g., via an alternative path 206, to the next untraveled waypoint 212U in the navigation route 202. In such a case, the robot 100 may fail to perform an important action, e.g., flashing a warning light, during execution of a mission, thus resulting in a potentially dangerous or otherwise undesirable situation.

In some existing systems, instructions for performing a particular action may be included within the navigation system 200, e.g., as a part of the route executor 220, and information may be included within a topological map 204 that triggers the route executor 220 to execute those instructions. As an example, the route executor 220 may include a software module that is configured to cause the robot 100 to operate in an operational mode optimized for traversing stairs, and one or more edges 214 of a topological map 204 may be annotated to indicate that the path corresponding to such edge(s) 214 includes stairs. When the route executor 220, while executing a navigation route 202 based on such a topological map 204, encounters an edge 214 that includes such an annotation, the route executor 220 may automatically execute the “stairs” software module.

Although building specialized functionality into the route executor 220 and invoking that functionality using appropriate edge annotations can be useful for certain commonly encountered circumstances, e.g., stair traversal, such a technique requires access to and intimate knowledge of the underlying functionality (e.g., the source code) of the route executor 220. As such, the creation of additional or special-purpose actions using such a technique can be onerous, or even impossible, e.g., for end users of the robot who typically do not have access to or an understanding of the source code of the route executor 220.

Some embodiments of the present disclosure relate to a system in which a first application, e.g., the route executor 220, that is responsible for controlling navigation of a robot 100 based on content of a topological map, e.g., the waypoints 212 and the edges 214 of the topological map 204, is configured to use information stored in the topological map 204 to automatically trigger calls to one or more services that are separate from the route executor 220. Such separate service(s) may be configured to perform special functions, such as to enable the robot 100 to safely and/or effectively navigate or maneuver, or otherwise operate, during execution of a mission. Such separate service(s) are depicted in FIG. 1B as navigation callback service(s) 186. Although FIG. 1B shows the navigation callback service(s) 186 as being included amongst the various operational components of the robot 100, in some implementations, one or more of the navigation callback service(s) 186 may additionally or alternatively be embodied within a computing system that is auxiliary to the robot 100, such as a payload computer appended to the robot 100, and/or one or more remote resources 162, 164 of a remote system 160 (described below).

As explained in more detail below, in some implementations, one or more edges 214 and/or waypoints 212 of a topological map 204 may be annotated to include the name or other identifier of a navigation callback service 186, and possibly also data that the identified navigation callback service 186 will need to perform a special function. As one example, a navigation callback service 186 may be configured to instruct the robot 100 to open a particular type of door (e.g., a pocket door) and may be named “pocket door traversal service.” Further, an edge 214 of a topological map 204 may be annotated to identify the “pocket door traversal service.” Such edge 214 may extend from one side of an opening for a pocket door to the other side of that same opening. In some implementations, the edge 214 may be further annotated to include information about the door to be opened, such as its dimensions, handle position, sliding direction, etc. As explained below, in some implementations, such annotations may have been added to the edge 214 in response to operator commands provided to a robot controller 188 during a mission recording process.

As noted previously, during execution of a mission, the route executor 220 may instruct other systems of the robot 100 to cause the robot 100 to move along various edges 214 between pairs of waypoints 212 identified on a topological map 204. During such execution, in response to the route executor 220 encountering an edge 214 with an annotation identifying a navigation callback service 186, the route executor 220 may make a call to the identified service to invoke the functionality it provides. For instance, upon the route executor 220 making such a call to the “pocket door traversal service” noted above, that service may control various systems of the robot 100 to determine whether the pocket door is already opened, to open it if it is closed, to travel through the door opening, and/or to close the door if it was previously closed. In some implementations, the route executor 220 may temporarily yield control of the robot 100 to the navigation callback service 186 that is called until the navigation callback service 186 indicates it has completed its function. In other implementations, the route executor 220 may maintain control of the robot 100, and the navigation callback service 186 that is called may perform its function in the background. Flashing warning lights and/or playing a warning sound is an example of a function that a navigation callback service 186 may be configured to perform in the background, with the route executor 220 maintaining control of the robot 100 in the meantime.

Several additional examples of functions that may be implemented by navigation callback services 186, as well as ways in which a topological map 204 may be annotated to trigger the route executor 220 to call such services, are provided below, following a detailed description of an example embodiment of the robot 100 as well as its component and associated systems.

Referring to FIG. 1A, a robot 100 may include a body 110 with locomotion based structures such as legs 120a-d coupled to the body 110 that enable the robot 100 to move about an environment 10. In some implementations, each leg 120 may be an articulable structure such that one or more joints J permit members 122 of the leg 120 to move. For instance, each leg 120 may include a hip joint J_{H} coupling an upper member 122, 122u of the leg 120 to the body 110, and a knee joint J_{K} coupling the upper member 122u of the leg 120 to a lower member 122_{L} of the leg 120. For impact detection, the hip joint J_{H} may be further broken down into abduction-adduction rotation of the hip joint J_{H} for occurring in a frontal plane of the robot 100 (i.e., an X-Z plane extending in directions of the x-direction axis Aₓ and the z-direction axis A_{Z}) and a flexion-extension rotation of the hip joint J_{H} for occurring in a sagittal plane of the robot 100 (i.e., a Y-Z plane extending in directions of the y-direction axis A_{Y} and the z-direction axis A_{Z}). Although FIG. 1A depicts a quadruped robot with four legs 120a-d, it should be appreciated that the robot 100 may include any number of legs or locomotive based structures (e.g., a biped or humanoid robot with two legs) that provide a means to traverse the terrain within the environment 10.

In order to traverse the terrain, each leg 120 may have a distal end 124 that contacts a surface 14 of the terrain (i.e., a traction surface). In other words, the distal end 124 of the leg 120 is the end of the leg 120 used by the robot 100 to pivot, plant, or generally provide traction during movement of the robot 100. For example, the distal end 124 of a leg 120 may correspond to a “foot” of the robot 100. In some examples, although not shown, the distal end 124 of the leg 120 may include an ankle joint such that the distal end 124 is articulable with respect to the lower member 122_{L} of the leg 120.

In the illustrated example, the robot 100 includes an arm 126 that functions as a robotic manipulator. The arm 126 may be configured to move about multiple degrees of freedom in order to engage elements of the environment 10 (e.g., objects within the environment 10). In some implementations, the arm 126 may include one or more members 128, where the members 128 are coupled by joints J such that the arm 126 may pivot or rotate about the joint(s) J. For instance, with more than one member 128, the arm 126 may be configured to extend or to retract. To illustrate an example, FIG. 1A depicts the arm 126 with three members 128 corresponding to a lower member 128_{L}, an upper member 128_{U}, and a hand member 128_{H} (e.g., also referred to as an end-effector 128_{H}). Here, the lower member 128L may rotate or pivot about one or more arm joints J_{A} located adjacent to the body 110 (e.g., where the arm 126 connects to the body 110 of the robot 100). For example, FIG. 1A depicts the arm 126 able to rotate about a first arm joint J_{A1} or yaw arm joint. With a yaw arm joint, the arm 126 is able to rotate in 360 degrees (or some portion thereof) axially about a vertical gravitational axis (e.g., shown as A_{z}) of the robot 100. The lower member 128_{L} may pivot (e.g., while rotating) about a second arm joint J_{A2}. For instance, the second arm joint J_{A2} (shown adjacent the body 110 of the robot 100) allows the arm 126 to pitch to a particular angle (e.g., raising or lowering one or more members 128 of the arm 126). The lower member 128_{L} may be coupled to the upper member 128_{U} at a third arm joint J_{A3} and the upper member 128_{U} may be coupled to the hand member 128_{H} at a fourth arm joint J_{A4}. In some examples, such as FIG. 1A, the hand member 128_{H} or end-effector 128_{H} may be a mechanical gripper that includes a one or more moveable jaws configured to perform different types of grasping of elements within the environment 10. In the example shown, the end-effector 128_{H} includes a fixed first jaw and a moveable second jaw that grasps objects by clamping the object between the jaws. The moveable jaw may be configured to move relative to the fixed jaw in order to move between an open position for the gripper and a closed position for the gripper (e.g., closed around an object).

In some implementations, the arm 126 may include additional joints J_{A} such as the fifth arm joint J_{A5} and/or the sixth arm joint J_{A6}. The fifth joint J_{A5} may be located near the coupling of the upper member 128_{U} to the hand member 128_{H} and may function to allow the hand member 128_{H} to twist or to rotate relative to the lower member 128_{U}. In other words, the fifth arm joint J_{A4} may function as a twist joint similarly to the fourth arm joint J_{A4} or wrist joint of the arm 126 adjacent the hand member 128_{H}. For instance, as a twist joint, one member coupled at the joint J may move or rotate relative to another member coupled at the joint J (e.g., a first member portion coupled at the twist joint is fixed while the second member portion coupled at the twist joint rotates). Here, the fifth joint J_{A5} may also enable the arm 126 to turn in a manner that rotates the hand member 128_{H} such that the hand member 128_{H} may yaw instead of pitch. For instance, the fifth joint J_{A5 may} allow the arm 126 to twist within a 180 degree range of motion such that the jaws associated with the hand member 128_{H} may pitch, yaw, or some combination of both. This may be advantageous for hooking some portion of the arm 126 around objects or refining the how the hand member 128_{H} grasps an object. The sixth arm joint J_{A6} may function similarly to the fifth arm joint J_{A5} (e.g., as a twist joint). For example, the sixth arm joint J_{A6 may} also allow a portion of an arm member 128 (e.g., the upper arm member 128_{U}) to rotate or twist within a 180 degree range of motion (e.g., with respect to another portion of the arm member 128 or another arm member 128). Here, a combination of the range of motion from the fifth arm joint J_{A5} and the sixth arm joint J_{A6} may enable 360 degree rotation. In some implementations, the arm 126 may connect to the robot 100 at a socket on the body 110 of the robot 100. In some configurations, the socket may be configured as a connector such that the arm 126 may attach or detach from the robot 100 depending on whether the arm 126 is needed for operation. In some examples, the first and second arm joints J_{A1,2} may be located at, adjacent to, or a portion of the socket that connects the arm 126 to the body 110.

The robot 100 may have a vertical gravitational axis (e.g., shown as a Z-direction axis A_{Z}) along a direction of gravity, and a center of mass CM, which is a point where the weighted relative position of the distributed mass of the robot 100 sums to zero. The robot 100 may further have a pose P based on the CM relative to the vertical gravitational axis A_{Z} (i.e., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 may alter the pose P of the robot 100 (i.e., the combination of the position of the CM of the robot and the attitude or orientation of the robot 100). Here, a height (i.e., vertical distance) generally refers to a distance along (e.g., parallel to) the z-direction (i.e., z-axis A_{Z}). The sagittal plane of the robot 100 corresponds to the Y-Z plane extending in directions of the y-direction axis A_{Y} and the z-direction axis A_{Z}. In other words, the sagittal plane bisects the robot 100 into a left and right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a support surface 14 where distal ends 124 of the legs 120 of the robot 100 may generate traction to help the robot 100 move about the environment 10. Another anatomical plane of the robot 100 is the frontal plane that extends across the body 110 of the robot 100 (e.g., from a left side of the robot 100 with a first leg 120a to a right side of the robot 100 with a second leg 120b). The frontal plane spans the X-Z plane by extending in directions of the x-direction axis A_{X} and the z-direction axis A_{Z}.

When a legged robot moves about the environment 10, the legs 120 of the robot may undergo a gait cycle. Generally, a gait cycle begins when a leg 120 touches down or contacts a support surface 14 and ends when that same leg 120 once again contacts the ground surface 14. The touching down of a leg 120 may also be referred to as a “footfall” defining a point or position where the distal end 124 of a locomotion-based structure 120 falls into contact with the support surface 14. The gait cycle may predominantly be divided into two phases, a swing phase and a stance phase. During the swing phase, a leg 120 may undergo (i) lift-off from the support surface 14 (also sometimes referred to as toe-off and the transition between the stance phase and swing phase), (ii) flexion at a knee joint J_{K} of the leg 120, (iii) extension of the knee joint J_{K} of the leg 120, and (iv) touchdown (or footfall) back to the support surface 14. Here, a leg 120 in the swing phase is referred to as a swing leg 120_{SW}. As the swing leg 120_{SW} proceeds through the movement of the swing phase 120_{SW}, another leg 120 performs the stance phase. The stance phase refers to a period of time where a distal end 124 (e.g., a foot) of the leg 120 is on the support surface 14. During the stance phase, a leg 120 may undergo (i) initial support surface contact which triggers a transition from the swing phase to the stance phase, (ii) loading response where the leg 120 dampens support surface contact, (iii) mid-stance support for when the contralateral leg (i.e., the swing leg 120_{SW}) lifts-off and swings to a balanced position (about halfway through the swing phase), and (iv) terminal-stance support from when the CM of the robot 100 is over the leg 120 until the contralateral leg 120 touches down to the support surface 14. Here, a leg 120 in the stance phase is referred to as a stance leg 120_{ST}.

In order to maneuver about the environment 10 or to perform tasks using the arm 126, the robot 100 may include a sensor system 130 with one or more sensors 132, 132a-n. For instance, FIG. 1A illustrates a first sensor 132, 132a mounted at a head of the robot 100, a second sensor 132, 132b mounted near the hip of the second leg 120b of the robot 100, a third sensor 132, 132c corresponding one of the sensors 132 mounted on a side of the body 110 of the robot 100, a fourth sensor 132, 132d mounted near the hip of the fourth leg 120d of the robot 100, and a fifth sensor 132, 132e mounted at or near the end-effector 128_{H} of the arm 126 of the robot 100. The sensors 132 may include vision/image sensors, inertial sensors (e.g., an inertial measurement unit (IMU)), force sensors, and/or kinematic sensors. Some examples of sensors 132 include a camera such as a stereo camera, a time-of-flight (TOF) sensor, a scanning light-detection and ranging (LIDAR) sensor, or a scanning laser-detection and ranging (LADAR) sensor. In some implementations, the respective sensors 132 may have corresponding fields of view Fᵥ, defining a sensing range or region corresponding to the sensor 132. For instance, FIG. 1A depicts a field of a view Fᵥ for the robot 100. Each sensor 132 may be pivotable and/or rotatable such that the sensor 132 may, for example, change the field of view F_{V} about one or more axis (e.g., an x-axis, a y-axis, or a z-axis in relation to a ground plane).

In some implementations, the sensor system 130 may include sensor(s) 132 coupled to a joint J. In some implementations, these sensors 132 may be coupled to a motor that operates a joint J of the robot 100 (e.g., sensors 132, 132a-b). Here, these sensors 132 may generate joint dynamics in the form of joint-based sensor data 134 (shown in FIG. 1B). Joint dynamics collected as joint-based sensor data 134 may include joint angles (e.g., an upper member 122u relative to a lower member 122_{L}), joint speed (e.g., joint angular velocity or joint angular acceleration), and/or joint torques experienced at a joint J (also referred to as joint forces). Here, joint-based sensor data 134 generated by one or more sensors 132 may be raw sensor data, data that is further processed to form different types of joint dynamics, or some combination of both. For instance, a sensor 132 may measure joint position (or a position of member(s) 122 coupled at a joint J) and systems of the robot 100 may perform further processing to derive velocity and/or acceleration from the positional data. In other examples, one or more sensors 132 may be configured to measure velocity and/or acceleration directly.

When surveying a field of view F_{V} with a sensor 132, the sensor system 130 may likewise generate sensor data 134 (also referred to as image data) corresponding to the field of view F_{V}. The sensor system 130 may generate the field of view Fᵥ with a sensor 132 mounted on or near the body 110 of the robot 100 (e.g., sensor(s) 132a, 132b). The sensor system may additionally and/or alternatively generate the field of view Fᵥ with a sensor 132 mounted at or near the end-effector 128_{H} of the arm 126 (e.g., sensor(s) 132c).

The one or more sensors 132 may capture sensor data 134 that defines the three-dimensional point cloud for the area within the environment 10 about the robot 100. In some examples, the sensor data 134 may be image data that corresponds to a three-dimensional volumetric point cloud generated by a three-dimensional volumetric image sensor 132.

Additionally or alternatively, when the robot 100 is maneuvering about the environment 10, the sensor system 130 may gather pose data for the robot 100 that includes inertial measurement data (e.g., measured by an IMU). In some examples, the pose data may include kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the environment 10 about the robot 100.

As the sensor system 130 gathers sensor data 134, a computing system 140 may store, process, and/or communicate the sensor data 134 to various systems of the robot 100 (e.g., the computing system 140, the control system 170, the perception system 180, and/or the navigation system 200). In order to perform computing tasks related to the sensor data 134, the computing system 140 of the robot 100 may include data processing hardware 142 and memory hardware 144. The data processing hardware 142 may be configured to execute instructions stored in the memory hardware 144 to perform computing tasks related to activities (e.g., movement and/or movement-based activities) for the robot 100. Generally speaking, the computing system 140 refers to one or more instances of data processing hardware 142 and/or memory hardware 144.

With continued reference to FIGS. 1A and 1B, in some implementations, the computing system 140 may be a local system located on the robot 100. When located on the robot 100, the computing system 140 may be centralized (i.e., in a single location/area on the robot 100, for example, the body 110 of the robot 100), decentralized (i.e., located at various locations about the robot 100), or a hybrid combination of both (e.g., where a majority of centralized hardware and a minority of decentralized hardware). A decentralized computing system 140 may, for example, allow processing to occur at an activity location (e.g., at motor that moves a joint of a leg 120) while a centralized computing system 140 may, for example, allow for a central processing hub that communicates to systems located at various positions on the robot 100 (e.g., communicate to the motor that moves the joint of the leg 120).

Additionally or alternatively, the computing system 140 may include computing resources that are located remotely from the robot 100. For instance, the computing system 140 may communicate via a network 150 with a remote system 160 (e.g., a remote computer/server or a cloud-based environment). Much like the computing system 140, the remote system 160 may include remote computing resources such as remote data processing hardware 162 and remote memory hardware 164. Here, sensor data 134 or other processed data (e.g., data processing locally by the computing system 140) may be stored in the remote system 160 and may be accessible to the computing system 140. In some implementations, the computing system 140 may be configured to utilize the remote resources 162, 164 as extensions of the computing resources 142, 144 such that resources of the computing system 140 may reside on resources of the remote system 160.

In some implementations, as shown in FIGS. 1A and 1B, the robot 100 may include a control system 170 and a perception system 180. The perception system 180 may be configured to receive the sensor data 134 from the sensor system 130 and process the sensor data 134 to generate one or more perception maps 182. The perception system 180 may communicate such perception map(s) 182 to the control system 170 in order to perform controlled actions for the robot 100, such as moving the robot 100 about the environment 10. In some implementations, by having the perception system 180 separate from, yet in communication with the control system 170, processing for the control system 170 may focus on controlling the robot 100 while the processing for the perception system 180 may focus on interpreting the sensor data 134 gathered by the sensor system 130. For instance, these systems 170, 180 may execute their processing in parallel to ensure accurate, fluid movement of the robot 100 in an environment 10.

In some implementations, the control system 170 may include one or more controllers 172, a path generator 174, a step locator 176, and a body planner 178. The control system 170 may be configured to communicate with at least one sensor system 130 and any other system of the robot 100 (e.g., the perception system 180 and/or the navigation system 200). The control system 170 may perform operations and other functions using hardware 140. The controller(s) 172 may be configured to control movement of the robot 100 to traverse about the environment 10 based on input or feedback from the systems of the robot 100 (e.g., the control system 170, the perception system 180, and/or the navigation system 200). This may include movement between poses and/or behaviors of the robot 100. For example, the controller(s) 172 may control different footstep patterns, leg patterns, body movement patterns, or vision system sensing patterns.

In some implementations, the controller(s) 172 may include a plurality of controllers 172 where each of the controllers 172 may be configured to operate the robot 100 at a fixed cadence. A fixed cadence refers to a fixed timing for a step or swing phase of a leg 120. For example, an individual controller 172 may instruct the robot 100 to move the legs 120 (e.g., take a step) at a particular frequency (e.g., step every 250 milliseconds, 350 milliseconds, etc.). With a plurality of controllers 172, where each controller 172 is configured to operate the robot 100 at a fixed cadence, the robot 100 can experience variable timing by switching between the different controllers 172. In some implementations, the robot 100 may continuously switch/select fixed cadence controllers 172 (e.g., re-selects a controller 172 every three milliseconds) as the robot 100 traverses the environment 10.

In some implementations, the control system 170 may additionally or alternatively include one or more specialty controllers 172 that are dedicated to a particular control purpose. For example, the control system 170 may include one or more stair controllers dedicated to planning and coordinating movement of the robot 100 to traverse a set of stairs. For instance, a stair controller may ensure the footpath for a swing leg 120_{SW} maintains a swing height to clear a riser and/or edge of a stair. Other specialty controllers 172 may include the path generator 174, the step locator 176, and/or the body planner 178.

Referring to FIG. 1B, the path generator 174 may be configured to determine horizontal motion for the robot 100. As used herein, the term “horizontal motion” refers to translation (i.e., movement in the X-Y plane) and/or yaw (i.e., rotation about the Z-direction axis A_{z}) of the robot 100. The path generator 174 may determine obstacles within the environment 10 about the robot 100 based on the sensor data 134. The path generator 174 may determine the trajectory of the body 110 of the robot for some future period (e.g., for the next 1-1.5 seconds). Such determination of the trajectory of the body 110 by the path generator 174 may occur much more frequently, however, such as hundreds of times per second. In this manner, in some implementations, the path generator 174 may determine a new trajectory for the body 110 every few milliseconds, with each new trajectory being planned for a period of 1-1.5 or so seconds into the future.

The path generator 174 may communicate information concerning currently planned trajectory, as well as identified obstacles, to the step locator 176 such that the step locator 176 may identify foot placements for legs 120 of the robot 100 (e.g., locations to place the distal ends 124 of the legs 120 of the robot 100). The step locator 176 may generate the foot placements (i.e., locations where the robot 100 should step) using inputs from the perception system 180 (e.g., perception map(s) 182). The body planner 178, much like the step locator 176, may receive inputs from the perception system 180 (e.g., perception map(s) 182). Generally speaking, the body planner 178 may be configured to adjust dynamics of the body 110 of the robot 100 (e.g., rotation, such as pitch or yaw and/or height of CM) to successfully move about the environment 10.

The perception system 180 may enable the robot 100 to move more precisely in a terrain with various obstacles. As the sensors 132 collect sensor data 134 for the space about the robot 100 (i.e., the robot's environment 10), the perception system 180 may use the sensor data 134 to form one or more perception maps 182 for the environment 10. In some implementations, the perception system 180 may also be configured to modify an existing perception map 182 (e.g., by projecting sensor data 134 on a preexisting perception map) and/or to remove information from a perception map 182.

In some implementations, the one or more perception maps 182 generated by the perception system 180 may include a ground height map 182, 182a, a no-step map 182, 182b, and a body obstacle map 182, 182c. The ground height map 182a refers to a perception map 182 generated by the perception system 180 based on voxels from a voxel map. In some implementations, the ground height map 182a may function such that, at each X-Y location within a grid of the perception map 182 (e.g., designated as a cell of the ground height map 182a), the ground height map 182a specifies a height. In other words, the ground height map 182a may convey that, at a particular X-Y location in a horizontal plane, the robot 100 should step at a certain height.

The no-step map 182b generally refers to a perception map 182 that defines regions where the robot 100 is not allowed to step in order to advise the robot 100 when the robot 100 may step at a particular horizontal location (i.e., location in the X-Y plane). In some implementations, much like the body obstacle map 182c and the ground height map 182a, the no-step map 182b may be partitioned into a grid of cells in which each cell represents a particular area in the environment 10 of the robot 100. For instance, each cell may correspond to a three centimeter square within an X-Y plane within the environment 10. When the perception system 180 generates the no-step map 182b, the perception system 180 may generate a Boolean value map where the Boolean value map identifies no-step regions and step regions. A no-step region refers to a region of one or more cells where an obstacle exists while a step region refers to a region of one or more cells where an obstacle is not perceived to exist. The perception system 180 may further process the Boolean value map such that the no-step map 182b includes a signed-distance field. Here, the signed-distance field for the no-step map 182b may include a distance to a boundary of an obstacle (e.g., a distance to a boundary of the no-step region 244) and a vector “v” (e.g., defining nearest direction to the boundary of the no-step region 244) to the boundary of an obstacle.

The body obstacle map 182c may be used to determine whether the body 110 of the robot 100 overlaps a location in the X-Y plane with respect to the robot 100. In other words, the body obstacle map 182c may identify obstacles for the robot 100 to indicate whether the robot 100, by overlapping at a location in the environment 10, risks collision or potential damage with obstacles near or at the same location. As a map of obstacles for the body 110 of the robot 100, systems of the robot 100 (e.g., the control system 170) may use the body obstacle map 182c to identify boundaries adjacent, or nearest to, the robot 100 as well as to identify directions (e.g., an optimal direction) to move the robot 100 in order to avoid an obstacle. In some implementations, much like other perception maps 182, the perception system 182 may generate the body obstacle map 182c according to a grid of cells (e.g., a grid of the X-Y plane). Here, each cell within the body obstacle map 182c may include a distance from an obstacle and a vector pointing to the closest cell that is an obstacle (i.e., a boundary of the obstacle).

Referring further to FIG. 1B, the robot 100 may also include a navigation system 200, a mission execution system 184, and a navigation callback service 186. The navigation system 200, described in detail below in connection with FIG. 2, may be a system of the robot 100 that navigates the robot 100 along a path referred to as a navigation route 202 in order to traverse an environment 10. The navigation system 200 may be configured to receive the navigation route 202 as input or to generate the navigation route 202 (e.g., in its entirety or some portion thereof). To generate the navigation route 202 and/or to guide the robot 100 along the navigation route 202, the navigation system 200 may be configured to operate in conjunction with the control system 170 and/or the perception system 180. For instance, the navigation system 200 may receive perception maps 182 that may inform decisions performed by the navigation system 200 or otherwise influence some form of mapping performed by the navigation system 200 itself. The navigation system 200 may operate in conjunction with the control system 170 such that one or more controllers 172 and/or specialty controller(s) 174, 176, 178 may control the movement of components of the robot 100 (e.g., legs 120 and/or the arm 126) to navigate along the navigation route 202.

The mission execution system 184 may be a system of the robot 100 that is responsible for executing recorded missions. A recorded mission may, for example, specify a sequence of one or more actions that the robot 100 is to perform at respective waypoints 212 defined on a topological map 204 (shown in FIG. 2).

The navigation callback service(s) 186, which are also described in further detail below, may be one or more systems of the robot 100 that may be called by the navigation system 200, e.g., by the route executor 220 shown in FIG. 2, based on information embedded within a topographical map 204, in accordance with some aspects of the present disclosure. For example, in some implementations, one or more edges 214 and/or waypoints 212 of a topographical map 204 may be annotated (e.g., based on user input provided during a mission recording process—described below) to include information that identifies one or more navigation callback services 186 that are to be called, as well as any data such navigation callback service(s) 186 will need to perform their respective functions.

In other implementations, a topological map 204 may be annotated in other ways to identify locations at which and/or areas in which calls to one or more navigation callback services 186 are to be made. For instance, in some implementations, a user interface for the robot 100 (e.g., on the robot controller 188 or the remote system 160) may be configured to enable an operator to identify a region on a previously-generated topological map 204, e.g., using a square, rectangle, circle, or otherwise, and may annotate the topological map 204 to indicate that the navigation generator 210 is to call a particular navigation callback service 186 whenever the robot 100 enters that region. In some implementations, for example, an indicator of a designated region (e.g., a square, rectangle, circle, etc.) may be added to the topological map 204 in response to instructions the operator provides to a user interface, and such region indicator (e.g., a square, rectangle, circle, etc.) may be annotated to identify a particular navigation callback service 186, as well as any data the identified navigation callback service 186 will need to perform its function. In such an implementation, any edges 214 and/or waypoints 212 that are within the bounds of the designated region (e.g., within the specified square, rectangle, circle, etc.) may “inherit” the properties (e.g., annotations) of the region indicator. For example, if an edge 214 is within the bounds of a region indicator that is annotated to identify a particular navigation callback service 186, when the route executor 220 encounters that edge 214 (or any other edge that is within the designated region) while controlling navigation of the robot 100, the route executor 220 may call the identified navigation callback service 186 and use any data specified in the region indicator annotation(s) when making such a call.

In some implementations, the navigation callback service(s) 186 may be located within a payload computer of the robot 100 that is separate from one or more other systems of the robot 100, such as the control system 170, the sensor system 130, the perception system 180, the navigation system 200, the mission execution system 184, etc. In some implementations, such a payload computer may be connected to the robot's primary computer system(s) using a high-speed communications link. Such a payload computer may, for instance, be independently configurable by an end user of the robot 100, e.g., using computing resources of the remote system 160 shown in FIG. 1B, to enable the provision of user-defined functionality to the robot 100.

As further explained below, when a route executor 220 (shown in FIG. 2) executes a navigation route 202 that includes an edge 214, a waypoint 212 and/or a region that has been annotated to identify a navigation callback service 186, upon the route executor 220 encountering that annotation while executing the navigation route 202, the route executor 220 may make a call to the navigation callback service 186 identified by the annotation to invoke the functionality provided by that service.

As additionally shown in FIG. 1B, in some implementations, a robot controller 188 may be in wireless (or wired) communication with the robot 100 (via the network 150 or otherwise) and may allow an operator to control the robot 100. In some implementations, the robot controller 188 may be a tablet computer with “soft” UI controls for the robot 100 being presented via a touchscreen of the tablet. An example screen 300 of such a tablet is described below in connection with FIG. 3. In other implementations, the robot controller 188 may instead take the form of a traditional video game controller, but possibly including a display screen, and may include a variety of physical buttons and/or soft buttons that can be depressed or otherwise manipulated to control the robot 100.

In some implementations, an operator may use the robot controller 188 to initiate a mission recording process. During such a process, the operator may direct movement of the robot 100 (e.g., via the robot controller 188) and instruct the robot 100 to take various “mission actions” (e.g., taking sensor readings, surveillance video, etc.) along the desired path of the mission. As a mission is being recorded, the robot 100 may generate a topological map 204 (shown in FIG. 2) including waypoints 212 at various locations along its path, as well as edges 214 between such waypoints 212. In some implementations, for each mission action the operator instructs the robot to perform, a new waypoint 212 may be added to the topological map 204 that is being generated on the robot 100. Further, for each such mission action, data may be stored in the topological map 204 and/or the mission recording to associate the mission action identified in the mission recording with the waypoint 212 of the topological map 204 at which that mission action was performed. In some implementations, at the end of the mission recording process, the topological map 204 generated during mission recording may be transferred to the robot controller 188 and/or some other computing resource (e.g., within the remote system 160), and may be stored in association with the mission recording.

The mission recording and, if not already present on the robot 100, the associated topological map 204, may be subsequently transferred to the robot 100, and the robot 100 may be instructed to execute the recorded mission. As noted above, during such execution, the mission execution system 184 may call out to various other services of the robot, such as the navigation system 200, a service for pointing a sensor at a particular target, a service for capturing data, etc.

A detailed description of the route executor 220 of the navigation system 200 will now be provided with reference to FIG. 2. As described above, a navigation route 202 that is executed by the route executor 220 may include a sequence of instructions that cause the robot 100 to move along a path corresponding to a sequence of waypoints 212 defined on a topological map 204 (shown in FIG. 2). As the route executor 220 guides the robot 100 through movements that follow the navigation route 202, the route executor 220 may determine whether the navigation route 202 becomes obstructed by an object. As noted above, in some implementations, the navigation route 202 may include one or more features of a topological map 204. For example, as previously described, such a topological map 204 may include waypoints 212 and edges 214 and the navigation route 202 may indicate that the robot 100 is to travel along a path that includes a particular sequence of those waypoints 212. In some implementations, the navigation route 202 may further include movement instructions that specify how the robot 100 is to move from one waypoint 212 to another. Such movement instructions may, for example, account for objects or other obstacles at the time of recording the waypoints 212 and edges 214 to the topological map 204.

Since the environment 10 may dynamically change from the time of recording the waypoints 212 to the topological map 204, the route executor 220 may be configured to determine whether the navigation route 202 becomes obstructed by an object that was not previously discovered when recording the waypoints 212 on the topological map 204 being used by the navigation route 202. Such an object may be considered an “unforeseeable obstacle” in the navigation route 202 because the initial mapping process that informs the navigation route 202 did not recognize the object in the obstructed location. This may occur, for example, when an object is moved or introduced to a mapped environment.

As shown in FIG. 2, when an unforeseeable obstacle obstructs the navigation route 202, the route executor 220 may attempt to generate an alternative path 206 to another feature on the topological map 204 that avoids the unforeseeable obstacle. This alternative path 206 may deviate from the navigation route 202 temporarily, but then resume the navigation route 202 after the deviation. Unlike other approaches to generate an obstacle avoidance path, the route executor 220 seeks to only temporarily deviate from the navigation route 202 to avoid the unforeseeable obstacle such that the robot 100 may return to using course features (e.g., like topological features from the topological map 204) for the navigation route 202. In this sense, successful obstacle avoidance for the route executor 220 occurs when an obstacle avoidance path both (i) avoids the unforeseeable obstacle and (ii) enables the robot 100 to resume some portion of the navigation route 202. This technique to merge back with the navigation route 202 after obstacle avoidance may be advantageous because the navigation route 202 may be important for task or mission performance for the robot 100 (or an operator of the robot 100). For instance, an operator of the robot 100 may have tasked the robot 100 to perform an inspection task at a waypoint 212 of the navigation route 202. By generating an obstacle avoidance route that continues on the navigation route 202 after obstacle avoidance, the navigation system 200 aims to promote task or mission success for the robot 100.

To illustrate, FIG. 1A depicts the robot 100 traveling along a navigation route 202 that includes three waypoints 212a-c. While moving along a first portion of the navigation route 202 (e.g., shown as a first edge 214a) from a first waypoint 212a to a second waypoint 212b, the robot 100 encounters an unforeseeable obstacle 20 depicted as a partial pallet of boxes. This unforeseeable obstacle 20 blocks the robot 100 from completing the first portion of the navigation route 202 to the second waypoint 212b. Here, the “X” over the second waypoint 212b symbolizes that the robot 100 is unable to travel successfully to the second waypoint 212b given the pallet of boxes. As depicted, the navigation route 202 would normally have a second portion (e.g., shown as a second edge 214b) that extends from the second waypoint 212b to a third waypoint 212c. Due to the unforeseeable object 20, however, the route executor 220 generates an alternative path 206 that directs the robot 100 to move to avoid the unforeseeable obstacle 20 and to travel to the third waypoint 212c of the navigation route 202 (e.g., from a point along the first portion of the navigation route 202). In this respect, the robot 100 may not be able to navigate successfully to one or more waypoints 212, such as the second waypoint 212b, but may resume a portion of the navigation route 202 after avoiding the obstacle 20. For instance, the navigation route 202 may include additional waypoints 212 subsequent to the third waypoint 212c and the alternative path 206 may enable the robot 100 to continue to those additional waypoints 212 after the navigation system 200 directs the robot 100 to the third waypoint 212c via the alternative path 206.

As shown in FIG. 2, and as briefly noted above, the navigation system 200 may include a navigation generator 210 that operates in conjunction with the route executor 220. The navigation generator 210 (also referred to as the generator 210) may be configured to construct a topological map 204 (e.g., during a mission recording process) as well as to generate the navigation route 202 based on the topological map 204. To generate the topological map 204, the navigation system 200 and, more particularly, the generator 210, may record sensor data corresponding to locations within an environment 10 that has been traversed or is being traversed by the robot 100 as waypoints 212. As noted above, a waypoint 212 may include a representation of what the robot 100 sensed (e.g., according to its sensor system 130) at a particular place within the environment 10. The generator 210 may generate waypoints 212, for example, based on the image data 134 collected by the sensor system 130 of the robot 100. For instance, a robot 100 may perform an initial mapping process where the robot 100 moves through the environment 10. While moving through the environment 10, systems of the robot 100, such as the sensor system 130 may gather data (e.g., sensor data 134) as a means to understand the environment 10. By obtaining an understanding of the environment 10 in this fashion, the robot 100 may later move about the environment 10 (e.g., autonomously, semi-autonomously, or with assisted operation by a user) using the information or a derivative thereof gathered from the initial mapping process.

In some implementations, the generator 210 may build the topological map 204 by executing at least one waypoint heuristic (e.g., waypoint search algorithm) that triggers the generator 210 to record a waypoint placement at a particular location in the topological map 204. For example, such a waypoint heuristic may be configured to detect a threshold feature detection within the image data 134 at a location of the robot 100 (e.g., when generating or updating the topological map 204). The generator 210 (e.g., using a waypoint heuristic) may identify features within the environment 10 that function as reliable vision sensor features offering repeatability for the robot 100 to maneuver about the environment 10. For instance, a waypoint heuristic of the generator 210 may be pre-programmed for feature recognition (e.g., programmed with stored features) or programmed to identify features where spatial clusters of volumetric image data 134 occur (e.g., corners of rooms or edges of walls). In response to the at least one waypoint heuristic triggering the waypoint placement, the generator 210 may record the waypoint 212 on the topological map 204. This waypoint identification process may be repeated by the generator 210 as the robot 100 drives through an area (e.g., the robotic environment 10). For instance, an operator of the robot 100 may manually drive the robot 100 through an area for an initial mapping process that establishes the waypoints 212 for the topological map 204.

When recording each waypoint 212, the generator 210 may associate waypoint edges 214 (also referred to as edges 214) with sequential pairs of respective waypoints 212 such that the topological map 204 produced by the generator 210 includes both waypoints 212 and edges 214 between pairs of those waypoints 212. An edge 214 may indicate how one waypoint 212 (e.g., a first waypoint 212a) is related to another waypoint 212 (e.g., a second waypoint 212b). For example, an edge 214 may represent a positional relationship between a pair of adjacent waypoints 212. In other words, an edge 214 may represent a connection or designated path between two waypoints 212 (e.g., the edge 214a shown in FIG. 2 may represent a connection between the first waypoint 212a and the second waypoint 212b).

In some implementations, each edge 214 may thus represent a path (e.g., a movement path for the robot 100) between the pair of waypoints 212 it interconnects. Further, in some implementations, individual edges 214 may also reflect additional useful information. In particular, the route executor 220 of the navigation system 200 may be configured to recognize particular annotations on the edges 214 and control other systems of the robot 100 to take actions that are indicated by such annotations. For example, one or more edges 214 may be annotated to include movement instructions that inform the robot 100 how to move or navigate between waypoints 212 they interconnect. Such movement instructions may, for example, identify a pose transformation for the robot 100 before it moves along the edge 214 between two waypoints 212. A pose transformation may thus describe one or more positions and/or orientations for the robot 100 to assume to successfully navigate along the edge 214 between two waypoints 212. In some implementations, an edge 214 may be annotated to specify a full three-dimensional pose transformation (e.g., six numbers). Some of these numbers represent estimates, such as a dead reckoning pose estimation, a vision based estimation, or other estimations based on kinematics and/or inertial measurements of the robot 100.

In some implementations, one or more edges 214 may additionally or alternatively include annotations that provide further an indication/description of the environment 10. Some examples of annotations include a description or an indication that an edge 214 is associated with or located on some feature of the environment 10. For instance, an annotation for an edge 214 may specify that the edge 214 is located on stairs or passes through a doorway. Such annotations may aid the robot 100 during maneuvering, especially when visual information is missing or lacking (e.g., due to the presence of a doorway). In some configurations, edge annotations may additionally or alternatively identify one or more directional constraints (which may also be referred to as “pose constraints”). Such directional constraints may, for example, specify an alignment and/or an orientation (e.g., a pose) for the robot 100 to enable it to navigate over or through a particular environment feature. For example, such an annotation may specify a particular alignment or pose the robot 100 is to assume before traveling up or down stairs or down a narrow corridor that may restrict the robot 100 from turning.

In some implementations, sensor data 134 may be associated with individual waypoints 212 of the topological map 204. Such sensor data 134 may have been collected by the sensor system 130 of the robot 100 when the generator 210 recorded respective waypoints 212 to the topological map 204. The sensor data 134 stored for the individual waypoints 212 may enable the robot 100 to localize by comparing real-time sensor data 134 gathered as the robot 100 traverses the environment 10 according to the topological map 204 (e.g., via a route 202) with sensor data 134 stored for the waypoints 212 of the topological map 204. In some configurations, after the robot 100 moves along an edge 214 (e.g., with the goal of arriving at a target waypoint 212), the robot 100 may localize by directly comparing real-time sensor data 134 with the sensor data 134 associated with the intended target waypoint 212 of the topological map 204. In some implementations, by storing raw or near-raw sensor data 134 (i.e., with minimal processing) for the waypoints 212 of the topological map 204, the robot 100 may use real-time sensor data 134 to localize efficiently as the robot 100 maneuvers within the mapped environment 10. In some examples, an iterative closest points (ICP) algorithm may be used to localize the robot 100 with respect to a given waypoint 212.

By producing the topological map 204 using waypoints 212 and edges 214, the topological map 204 may be locally consistent (e.g., spatially consistent within an area due to neighboring waypoints), but need not be globally accurate and/or consistent. That is, as long as geometric relations (e.g., edges 214) between adjacent waypoints 212 are roughly accurate, the topological map 204 does not require precise global metric localization for the robot 100 and any sensed objects within the environment 10. As such, a navigation route 202 derived or built using the topological map 204 also does not need precise global metric information. Moreover, because the topological map 204 may be built based on waypoints 212 and relationships between waypoints (e.g., edges 214), the topological map 204 may be considered an abstraction or high-level map, as opposed to a metric map. That is, in some implementations, the topological map 204 may be devoid of other metric data about the mapped environment 10 that does not relate to waypoints 212 or their corresponding edges 214. For instance, in some implementations, the mapping process (e.g., performed by the generator 210) that creates the topological map 204 may not store or record other metric data, and/or the mapping process may remove recorded metric data to form a topological map 204 of waypoints 212 and edges 214. Either way, navigating with the topological map 204 may simplify the hardware needed for navigation and/or the computational resources used during navigation. That is, topological-based navigation may operate with low-cost vision and/or low-cost inertial measurement unit (IMU) sensors when compared to navigation using metric localization that often requires expensive LIDAR sensors and/or expensive IMU sensors. Metric-based navigation tends to demand more computational resources than topological-based navigation because metric-based navigation often performs localization at a much higher frequency than topological navigation (e.g., with waypoints 212). For instance, the common navigation approach of Simultaneous Localization and Mapping (SLAM) using a global occupancy grid is constantly performing robot localization.

Referring to FIG. 2, the generator 210 may record a plurality of waypoints 212, 212a-n on a topological map 204. From the plurality of recorded waypoints 212, the generator 210 may select some number of the recorded waypoints 212 as a sequence of waypoints 212 that form the navigation route 202 for the robot 100. In some implementations, an operator of the robot 100 may use the generator 210 to select or build a sequence of waypoints 212 to form the navigation route 202. In some implementations, the generator 210 may generate the navigation route 202 based on receiving a destination location and a starting location for the robot 100. For instance, the generator 210 may match the starting location with a nearest waypoint 212 and similarly match the destination location with a nearest waypoint 212. The generator 210 may then select some number of waypoints 212 between these nearest waypoints 212 to generate the navigation route 202.

In some configurations, the generator 210 may receive, e.g., as input from the mission execution system 184, a mission recording and possibly also an associated topological map 204, and, in response, may generate a navigation route 202 that includes the various waypoints 212 that are included in the mission recording, as well as intermediate waypoints 212 and edges between pairs of waypoints 212. For instance, for a mission to inspect different locations on a pipeline, the generator 210 may receive a mission recording identifying waypoints 212 at which inspections are to occur as well as a topological map 204 generated during the recording process, and may generate a navigation route 202 that includes waypoints 212 that coincide with the identified inspection locations. In the example shown in FIG. 2, the generator 210 has generated the navigation route 202 with a sequence of waypoints 212 that include nine waypoints 212a-i and their corresponding edges 214a-h. FIG. 2 illustrates each waypoint 212 of the navigation route 202 in a double circle, while recorded waypoints 212 that are not part of the navigation route 202 have only a single circle. As illustrated, the generator 210 may then communicate the navigation route 202 to the route executor 220.

The route executor 220 may be configured to receive and to execute the navigation route 202. To execute the navigation route 202, the route executor 220 may coordinate with other systems of the robot 100 to control the locomotion-based structures of the robot 100 (e.g., the legs) to drive the robot 100 through the sequence of waypoints 212 that are included in the navigation route 202. For instance, the route executor 220 may communicate the movement instructions associated with edges 214 connecting waypoints 212 in the sequence of waypoints 212 of the navigation route 202 to the control system 170. The control system 170 may then use such movement instructions to position the robot 100 (e.g., in an orientation) according to one or more pose transformations to successfully move the robot 100 along the edges 214 of the navigation route 202.

While the robot 100 is traveling along the navigation route 202, the route executor 220 may also determine whether the robot 100 is unable to execute a particular movement instruction for a particular edge 214. For instance, the robot 100 may be unable to execute a movement instruction for an edge 214 because the robot 100 encounters an unforeseeable obstacle 20 while moving along the edge 214 to a waypoint 212. Here, the route executor 220 may recognize that an unforeseeable obstacle 20 blocks the path of the robot 100 (e.g., using real-time or near real-time sensor data 134) and may be configured to determine whether an alternative path 206 for the robot 100 exists to an untraveled waypoint 212, 212U in the sequence of the navigation route 202. An untraveled waypoint 212U refers to a waypoint 212 of the navigation route 202 to which the robot 100 has not already successfully traveled. For instance, if the robot 100 had already traveled to three waypoints 212a-c of the nine waypoints 212a-i of the navigation route 202, the route executor 220 may try to find an alternative path 206 to one or the remaining six waypoints 212d-i, if possible. In this sense, the alternative path 206 may be an obstacle avoidance path that avoids the unforeseeable obstacle 20 and also a path that allows the robot 100 to resume the navigation route 202 (e.g., toward a particular goal or task). This means that after the robot 100 travels along the alternative path 206 to a destination of an untraveled waypoint 212U, the route executor 220 may continue executing the navigation route 202 from that destination of the alternative path 206. Such an approach may enable the robot 100 to return to navigation using the sparse topological map 204.

For example, referring to FIG. 2, if the unforeseeable obstacle 20 blocks a portion of the third edge 214c (e.g., blocks some portion of the third edge 214c and the fourth waypoint 212d), the robot 100 has already traveled to three waypoints 212a-c. In such a circumstance, the route executor 220 may generate an alternative path 206, which avoids the unforeseeable obstacle 20, to the fifth waypoint 212e, which is an untraveled waypoint 212U. The robot 100 may then continue traversing the sequence of waypoints 212 for the navigation route 202 from the fifth waypoint 212e. This means that the robot 100 would then travel to the untraveled portion following the sequence of waypoints 212 for the navigation route 202 (e.g., by using the movement instructions of edges 214 of the untraveled portion). In the illustrated example, the robot 100 would thus travel from the fifth waypoint 212e to the sixth, seventh, eighth, and finally ninth waypoints 212, 212f-i, barring the detection of some other unforeseeable object 20. This means that, although the unforeseeable object 20 was present along the third edge 214c, the robot 100 only missed a single waypoint, i.e., the fourth waypoint 212d, during its movement path while executing the navigation route 202.

In some implementations, when the route executor 220 determines that an unforeseeable obstacle 20 blocks an edge 214, the route executor 220 may determine that the topological map 204 fails to provide an alternative path 206 avoiding the unforeseeable obstacle 20. This is usually the case because the topological map 204 includes waypoints 212 and edges 214 that were recorded during the mapping process (e.g., by the generator 210). Since the unforeseeable obstacle 20 was not present at that time of mapping, the topological map 204 may fail to be able to generate an alternative path 206 on its own. In other words, the generator 210 did not anticipate needing a path or edge 214 resembling the alternative path 106 in FIG. 2, i.e., from the third waypoint 212c to the fifth waypoint 212e. This also means that the alternative path 206 is likely a path that does not correspond to an existing edge 214 in the topological map 204. Stated differently, the alternative path 206 results in a path between two waypoints 212 that were previously unconnected (e.g., by an edge 214) in the navigation route 202. In other implementations, the route executor 220 may assume that the presence of an unforeseeable obstacle 20 necessitates that the route executor 220 use other means besides the topological map 204 to generate the alternative path 206.

As noted above, FIG. 3 shows an example screen 300 of the robot controller 188 that may be manipulated by an operator to control operation of the robot 100. In the illustrated example, the robot controller 188 is a computing device (e.g., a tablet computer such as a Samsung Galaxy Tab, an Apple iPad, or a Microsoft Surface) that includes a touchscreen configured to present a number of “soft” UI control elements. As illustrated, in some implementations, the screen 300 may present a pair of joystick controllers 302, 304, a pair of slider controllers 306, 308, a pair of mode selection buttons 310, 312, and a camera selector switch 314.

In some implementations, the mode selection buttons 310, 312 may allow the operator to place the robot 100 in either a non-ambulatory mode, e.g., “stand,” upon selecting the mode selection button 310, or an ambulatory mode, e.g., “walk,” upon selecting the mode selection button 312. For example, in response to selection of the mode selection button 310, the robot controller 188 may cause a first pop-up menu to be presented that allows the operator to select from amongst several operational modes that do not involve translational movement (i.e., movement in the X-Y direction) by the robot 100. Examples of such non-ambulatory modes included “sit” and “stand.” Similarly, in response to selection of the mode selection button 312, the robot controller 188 may cause a second pop-up menu to be presented that allows the operator to select from amongst several operational modes that do involve translational movement by the robot 100. Examples of such ambulatory modes include “walk,” “crawl,” and “stairs.”

In some implementations, the functionality of one or both of the joystick controller 302, 304 and/or the slider controllers 306, 308 may depend upon the operational mode that is currently selected (via the mode selection buttons 310, 312). For instance, when a non-ambulatory mode (e.g., “stand”) is selected, the joystick controller 302 may control the pitch (i.e., rotation about the X-direction axis) and the yaw (i.e., rotation about the Z-direction axis A_{z}) of the body 110 of robot 100, whereas when an ambulatory mode (e.g., walk) is selected, the joystick controller 302 may instead control the translation (i.e., movement in the X-Y plane) of the body 110 of the robot 100. The slider controller 306 may control the height of the body 110 of the robot 100, e.g., to make is stand tall or crouch down. When an ambulatory mode (e.g., walk) is selected, the slider controller 308 may control the speed of the robot 100. In some implementations, the camera selector switch 314 may control which of the robot's cameras is selected to have its output displayed on the screen 300, and the joystick controller 304 may control the pan direction of the selected camera.

The create button 316 present on the screen 300 may, in some implementations, enable the operator of the robot controller 188 to select and invoke a process for creating a new action for the robot 100, e.g., while recording a mission. For instance, if the operator of the robot 100 wanted the robot 100 to acquire an image of a particular instrument within a facility, the operator could select the create button 316 to select and invoke a process for defining where and how the image is to be acquired. In some implementations, in response to selection of the create button 316, the robot controller 188 may present a list of actions, e.g., as a drop down or pop-up menu, that can be created for the robot 100. For example, in some implementations, various services for performing actions may register service definitions with the robot 100, e.g., via a grpc remote procedure call (gRPC) framework, and in response to selection of the create button 316, the robot controller 188 may present a list of the applicable services that have registered with the robot 100. In some implementations, individual services may have a service type associated with them, and only those services relating to the creation of actions for the robot 100 may be presented in response to selection of the create button 316. In some implementations, the callback service(s) 186 shown in FIG. 1B may be among the action-related services that have been registered with the robot 100.

FIG. 3 illustrates how the screen 300 may appear after the user has selected the create button 316 and has further selected a navigation callback service 186 (named “Nav Assist Look Both Ways”) that is to be used to perform an action. As shown, in some implementations, the name of the selected service may be presented in a status bar 318 on the screen 300. As also shown, the screen 300 may also present instructions 320 for adding an action using the selected navigation callback service 186, as well as a first UI button 322 that may be used to specify a location at which the robot 100 is to begin using the navigation callback service 186, and a second UI button 324 at which the robot 100 is to cease using the navigation callback service 186.

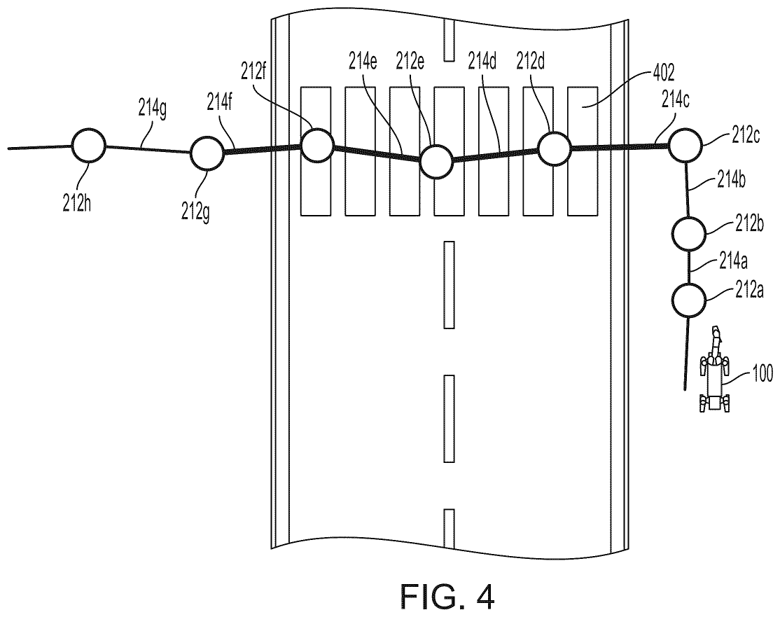

FIG. 4 shows a first example scenario in which an operator may, while recording a mission for the robot 100, create an action using the “Nav Assist Look Both Ways” navigation callback service 186. The “Nav Assist Look Both Ways” navigation callback service 186 may, for example, take steps to ensure that no forklifts or other hazards are in the vicinity of the robot 100, e.g., by looking both ways, before and/or during traversal of a road via a crosswalk 402. As illustrated in FIG. 4, as the operator manipulates the robot controller 188 to drive the robot 100 forward (in the upwards direction in FIG. 4), the navigation generator 210 of the robot 100 (shown in FIG. 2A) may create waypoints 212a, 212b, as well as an edge 214a between the waypoints 212a, 212b, on a topological map 204.

When the robot 100 reaches the location corresponding to the waypoint 212b (on one side of the crosswalk 402), the operator may press the create button 316 and select the “Nav Assist Look Both Ways” navigation callback service 186 as an action that is to be invoked. At this point, the screen 300 of the robot controller 188 may appear as shown in FIG. 3. Further to the instructions 320 presented on the screen 300, the operator may then drive the robot 100 to the “start” location for the selected navigation callback service 186, i.e., the location corresponding to the waypoint 212c shown in FIG. 4. The operator may then select the UI button 322 to confirm that the current location of the robot 100 is where operation of the selected navigation callback service 186 is to begin. In response to selecting the UI button 322, the navigation generator 210 of the robot 100 (shown in FIG. 2A) may create a waypoint 212c, as well as an edge 214b, on the topological map 204, and may then begin annotating subsequent edges 214, e.g., edges 214c, 214d, 214e, 214f and/or waypoints 212, e.g., waypoints 212d, 212e, 212f, that are added to the topological map 204, to indicate that the selected navigation callback service 186 is to be active as the robot 100 travels along the annotated edges 214, e.g., edges 214c, 214d, 214e, 214f. In FIG. 4, the lines representing the annotated edges 214c, 214d, 214e, 214f are thicker than the lines representing un-annotated edges 214. When the robot 100 reaches a location at which the selected navigation callback service 186 is no longer needed, e.g., a location corresponding to the waypoint 212g, the operator may select the UI button 324 to confirm that the current location of the robot 100 is where operation of the selected navigation callback 186 service is to cease. In response to selecting the UI button 324, the navigation generator 210 of the robot 100 (shown in FIG. 2A) may create the waypoint 212g, as well as the annotated edge 214f, on the topological map 204, and may cease annotating subsequent edges 214, e.g., edge 214g and/or waypoints 212, e.g. waypoint 212h, that are added to the topological map 204.

During playback of such a mission recording, after the robot 100 reaches the waypoint 212c, the route executor 220 (shown in FIG. 2A) may recognize that the edge 214c of the topological map 204 is annotated to identify the selected navigation callback service 186, i.e., the “Nav Assist Look Both Ways” service. Upon recognizing such an edge annotation, the route executor 220 may automatically call the identified navigation callback service 186, thus ensuring that the robot 100 takes special precautions and/or actions for crossing the road, as defined by the service, as it moves along the annotated edges 214c, 214d, 214e, 214f. In some implementations, for example, when the route executor 220 calls the “Nav Assist Look Both Ways” navigation callback service 186, the route executor 220 may temporarily yield control of the robot 100 to the service 186, and the service 186 may instruct the control system 170 of the robot 100 to halt forward motion until it is certain that no forklifts or other hazards are on the road. In other implementations, when the route executor 220 calls the “Nav Assist Look Both Ways” navigation callback service 186, the route executor 220 may additionally or alternatively instruct the service 186 to perform one or more actions in the background, without yielding control of the robot 100 to the service 186, such as by flashing warning lights and/or playing warning sounds, as the robot crosses the road in the crosswalk 402.

In some embodiments, because one or more special “crosswalk-crossing” functions may be defined by the edges 214c, 214d, 214e, 214f of the topological map 204, rather than as a part of the mission recording (e.g., as actions to be taken when the robot 100 reaches particular waypoints 212), the robot 100 will be controlled to perform the specialized function(s) any time it reaches an annotated edge 214c, 214d, 214e, 214f, and regardless of whether the route executor 220 re-routes the robot 100 around one or more waypoints 212 specified in a mission recording. As such, for the example scenario shown in FIG. 4, the robot 100 would not traverse the crosswalk 402 without performing the special function(s) provided by the “Nav Assist Look Both Ways” navigation callback service 186.

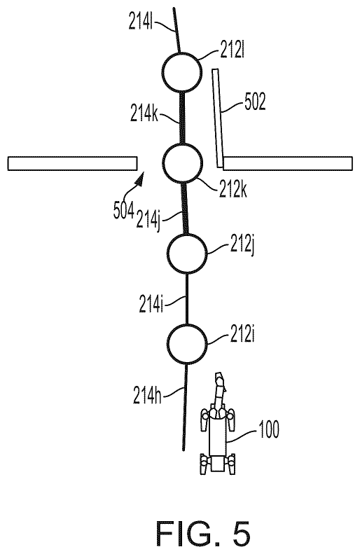

FIG. 5 shows a second example scenario in which an operator may, while recording a mission for the robot 100 (e.g., using the robot controller 188), create an action using a navigation callback service 186 that is configured to enable to the robot 100 to open a particular type of door 502. Such a navigation callback service 186 may, for example, be named “Special Door Opener.” As illustrated in FIG. 5, as the operator manipulates the robot controller 188 to drive the robot 100 forward (in the upwards direction in FIG. 5), the navigation generator 210 of the robot 100 (shown in FIG. 2A) may create a waypoint 212i, as well as an edge 214h preceding the waypoint 212i, on a topological map 204.

When the robot 100 reaches the location corresponding to the waypoint 212j (on one side of an opening 504 for the door 502), the operator may press the create button 316 (shown in FIG. 3) and select the “Special Door Opener” navigation callback service 186 as an action that is to be invoked. At this point in time, the screen 300 of the robot controller 188 may appear as shown in FIG. 3, except that the status bar 318 may include the text “Special Door Opener,” rather than “Nav Assist Look Both Ways.” Further to the instructions 320 presented on the screen 300, the operator may then drive the robot 100 to the “start” location for the selected navigation callback service 186, i.e., the location corresponding to the waypoint 212j shown in FIG. 5. The operator may then select the UI button 322 to confirm that the current location of the robot 100 is where operation of the selected navigation callback service 186 is to begin. In response to selecting the UI button 322, the navigation generator 210 of the robot 100 (shown in FIG. 2A) may create a waypoint 212j, as well as an edge 214i, on the topological map 204, and may then begin annotating subsequent edges 214, e.g., edges 214j and 214k and/or waypoints 212, e.g., waypoint 212k, that are added to the topological map 204, to indicate that the selected navigation callback service 186 is to be active as the robot 100 travels along the annotated edges, e.g., the edges 214j and 214k. In FIG. 5, the lines representing the annotated edges 214j and 214k are thicker than the lines representing un-annotated edges 214. When the robot 100 reaches a location at which the selected navigation callback service 186 is no longer needed, e.g., a location corresponding to the waypoint 212l, the operator may select the UI button 324 to confirm that the current location of the robot 100 is where operation of the selected navigation callback 186 service is to cease. In response to selecting the UI button 324, the navigation generator 210 of the robot 100 (shown in FIG. 2A) may create the waypoint 212l, as well as the annotated edge 214k, on the topological map 204, and may cease annotating subsequent edges 214, e.g., edge 214l and/or waypoints 212 that are added to the topological map 204. In other implementations, additional or different UI controls may alternatively be presented and used to achieve similar functionality. For instance, in some implementations, a user could press and hold a single UI button to indicate a “start” location of a navigation callback service 186 and may subsequently release the same button to indicate an “end” location for the service.

During playback of such a mission recording, after the robot 100 reaches the waypoint 212j, the route executor 220 (shown in FIG. 2A) may recognize that the edge 214j of the topological map 204 is annotated to identify the selected navigation callback service 186, e.g., the “Special Door Opener” service. Upon recognizing such an edge annotation, the route executor 220 may automatically call the identified navigation callback service 186, thus enabling the “Special Door Opener” callback service 186 to control the robot 100 to take special steps traverse the door opening 504, such as determining whether the door 502 is already opened, to open the door 502 if it is closed, to travel through the door opening 504, and/or to close the door 502 if it was previously closed. In some implementations, for example, when the route executor 220 calls the “Special Door Opener” navigation callback service 186, the route executor 220 may temporarily yield control of the robot 100 to the service 186, and the service 186 may instruct the control system 170 of the robot 100 to take one or more of the foregoing steps. In some implementations, the edges 214j and 214k may further be annotated to include information identifying one or more features of the door 502, such as its width, its swing direction, the position of its handle(s), etc. In such implementations, when the route executor 220 encounters one of the annotated edges 214j, 214k, the route executor 220 may send the additional information to the “Special Door Opener” navigation callback service 186 when it calls that service, to enable the Special Door Opener” navigation callback service 186 to use that information to facilitate opening of the door 502 and/or traversal of the door opening 504.

Advantageously, because one or more special “door opening traversal” functions may be defined by the edges 214j and 214k of the topological map 204, rather than as a part of the mission recording, e.g., as actions to be taken when the robot 100 reaches particular waypoints 212, the robot 100 will be controlled to perform the specialized function(s) any time it reaches an annotated edge 214j, 214k, and regardless of whether the route executor 220 re-routes the robot 100 around one or more waypoints 212 specified in a mission recording. As such, for the example scenario shown in FIG. the robot 100 would never traverse the door opening 504 without performing the special function(s) provided by the “Special Door Opener” navigation callback service 186.

It should be appreciated that many other types of navigation callback services 186 may additionally or alternatively be employed in some embodiments. Other possible scenarios in which navigation callback services 186 may be employed include, but are not limited to (A) pushing elevator buttons, (B) blocking one or more operations if a person or object is too close to the robot, (C) performing an action in the background, such as flashing lights and/or emitting a sound, and (D) emitting a Bluetooth signal to control another device, such as to open a door in which the robot is housed or can have its battery recharged.

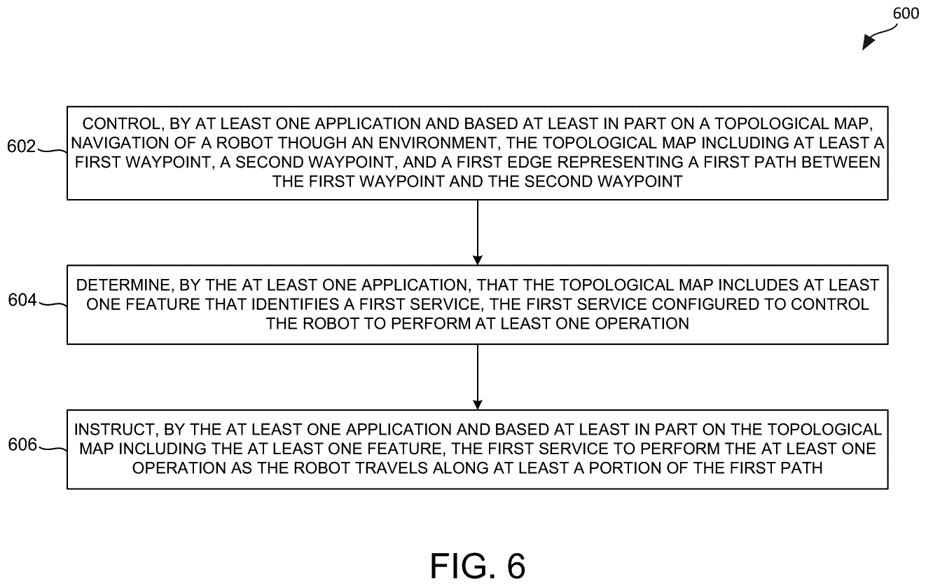

FIG. 6 shows an example routine 600 that may be executed by a robot, such as the robot 100 of FIGS. 1A-B, in accordance with some embodiments. As shown, the routine 600 may begin at an act 602, at which at least one application (e.g., the route executor 220 shown in FIG. 1B) may control navigation of a robot (e.g., the robot 100) through an environment (e.g., the environment 10). As indicated, in some implementations, such navigation may be controlled based at least in part on a topological map (e.g., the topological map 204 shown in FIG. 2). Such a topological map may, for example, include at least a first waypoint (e.g., the waypoint 212a), a second waypoint (e.g., the waypoint 212b), and a first edge (e.g., the edge 214a) representing a first path between the first waypoint and the second waypoint.

At an act 604 of the routine 600, the at least one application (e.g., the route executor 220) may determine that the topological map includes at least one feature that identifies a first service (e.g., a navigation callback service 186). In some implementations, the at least one feature may, for example, include an annotation of the first edge (e.g., the edge 204). In other implementations, the at least one feature may additionally or alternatively include a region indicator (e.g., a square, rectangle, circle, etc.) that encompasses the first edge (e.g., the edge 204) on the topological map (e.g., the topological map 204). As indicated, the first service (e.g., the identified navigation callback service 186) may be configured to control the robot to perform at least one operation (e.g., crossing a road at a crosswalk, opening a door, etc.).

In some implementations, the first service (e.g., the identified navigation callback service 186) may be separate from the at least one application (e.g., the route executor 220). For example, in some implementations, the first service may be executed using a different processing thread as the at least one application. In other implementations, the first service may additionally or alternatively be executed using one or more processors that is/are separate from one or more processors on which at least one application is executing. As noted above, for example, in some implementations, the navigation callback service(s) 186 may be located within a payload computer of the robot 100 that is separate from certain other systems of the robot 100, such as the control system 170, the sensor system 130, the perception system 180, the navigation system 200, the mission execution system 184, etc.

At an act 606 of the routine 600, the at least one application (e.g., the route executor 220) may, based at least in part on the topological map including the at least one feature, instruct the first service (e.g., the identified navigation callback service 186) to perform the at least one operation (e.g., crossing a road at a crosswalk, opening a door, etc.) as the robot 100 travels along at least a portion of the first path (e.g., the path represented by to the first edge).

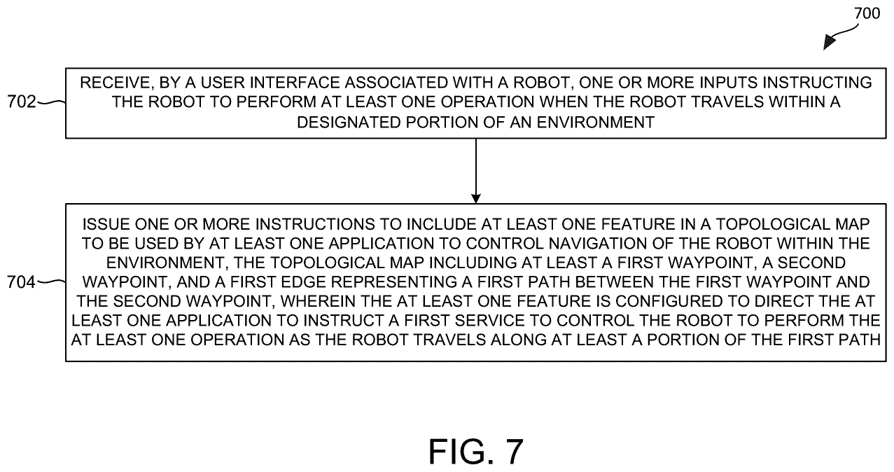

FIG. 7 shows an example routine 700 that may be executed by a robot controller, such as the robot controller 188 of FIG. 1B, in accordance with some embodiments. As shown, the routine 700 may begin at an act 702, at which the robot controller (e.g., the robot controller 188) may receive, by a user interface (e.g., the touchscreen 300 shown in FIG. 3) associated with a robot (e.g., the robot 100), one or more inputs (e.g., via the create button 316, the “confirm start” UI button 322 and/or the “confirm end” UI button 324) instructing the robot to perform at least one operation (e.g., crossing a road at a crosswalk, opening a door, etc.) when the robot travels within a designated portion of an environment.

At an act 704 of the routine 700, the robot controller (e.g., the robot controller 188) may issue one or more instructions to include at least one feature in a topological map (e.g., the topological map 204) to be used by at least one application (e.g., the route executor 220) to control navigation of the robot within the environment. As indicated, the topological map (e.g., the topological map 204) may include at least a first waypoint (e.g., the waypoint 212a), a second waypoint (e.g., the waypoint 212b), and a first edge (e.g., the edge 214a) representing a first path between the first waypoint and the second waypoint.

In some implementations, the at least one feature may, for example, include an annotation of the first edge (e.g., the edge 204). In other implementations, the at least one feature may additionally or alternatively include a region indicator (e.g., a square, rectangle, circle, etc.) that encompasses the first edge (e.g., the edge 204) on the topological map (e.g., the topological map 204). As indicated, the at least one feature may be configured to direct the at least one application (e.g., the route executor 220) to instruct a first service (e.g., a navigation callback service 186) to control the robot to perform the at least one operation (e.g., crossing a road at a crosswalk, opening a door, etc.) as the robot travels along at least a portion of the first path (e.g., the path represented by to the first edge).

In some implementations, the first service (e.g., the navigation callback service 186) may be separate from the at least one application (e.g., the route executor 220). In some implementations, for example, the first service may be executed using a different processing thread as the at least one application. In other implementations, the first service may additionally or alternatively be executed using one or more processors that is/are separate from one or more processors on which at least one application is executing. As noted above, for example, in some implementations, the navigation callback service(s) 186 may be located within a payload computer of the robot 100 that is separate from certain other systems of the robot 100, such as the control system 170, the sensor system 130, the perception system 180, the navigation system 200, the mission execution system 184, etc.

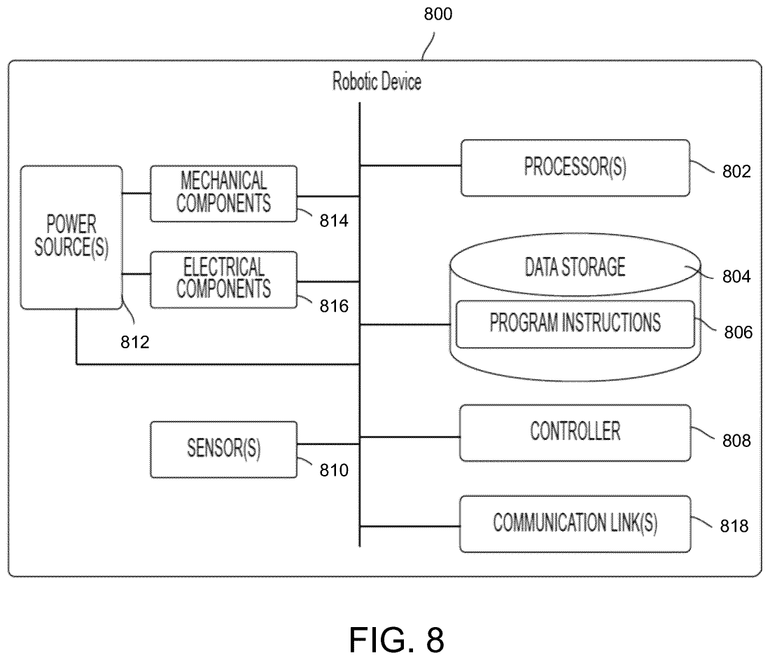

FIG. 8 illustrates an example configuration of a robotic device (or “robot”) 800, according to some embodiments. The robotic device 800 may, for example, correspond to the robot 100 described above. The robotic device 800 represents an illustrative robotic device configured to perform any of the techniques described herein. The robotic device 800 may be configured to operate autonomously, semi-autonomously, and/or using directions provided by user(s), and may exist in various forms, such as a humanoid robot, biped, quadruped, or other mobile robot, among other examples. Furthermore, the robotic device 800 may also be referred to as a robotic system, mobile robot, or robot, among other designations.

As shown in FIG. 8, the robotic device 800 may include processor(s) 802, data storage 804, program instructions 806, controller 808, sensor(s) 810, power source(s) 812, mechanical components 814, and electrical components 816. The robotic device 800 is shown for illustration purposes and may include more or fewer components without departing from the scope of the disclosure herein. The various components of robotic device 800 may be connected in any manner, including via electronic communication means, e.g., wired or wireless connections. Further, in some examples, components of the robotic device 800 may be positioned on multiple distinct physical entities rather on a single physical entity.

The processor(s) 802 may operate as one or more general-purpose processor or special purpose processors (e.g., digital signal processors, application specific integrated circuits, etc.). The processor(s) 802 may, for example, correspond to the data processing hardware 142 of the robot 100 described above. The processor(s) 802 can be configured to execute computer-readable program instructions 806 that are stored in the data storage 804 and are executable to provide the operations of the robotic device 800 described herein. For instance, the program instructions 806 may be executable to provide operations of controller 808, where the controller 808 may be configured to cause activation and/or deactivation of the mechanical components 814 and the electrical components 816. The processor(s) 802 may operate and enable the robotic device 800 to perform various functions, including the functions described herein.

The data storage 804 may exist as various types of storage media, such as a memory. The data storage 804 may, for example, correspond to the memory hardware 144 of the robot 100 described above. The data storage 804 may include or take the form of one or more non-transitory computer-readable storage media that can be read or accessed by processor(s) 802. The one or more computer-readable storage media can include volatile and/or non-volatile storage components, such as optical, magnetic, organic or other memory or disc storage, which can be integrated in whole or in part with processor(s) 802. In some implementations, the data storage 804 can be implemented using a single physical device (e.g., one optical, magnetic, organic or other memory or disc storage unit), while in other implementations, the data storage 804 can be implemented using two or more physical devices, which may communicate electronically (e.g., via wired or wireless communication). Further, in addition to the computer-readable program instructions 806, the data storage 804 may include additional data such as diagnostic data, among other possibilities.

The robotic device 800 may include at least one controller 808, which may interface with the robotic device 800 and may be either integral with the robotic device, or separate from the robotic device 800. The controller 808 may serve as a link between portions of the robotic device 800, such as a link between mechanical components 814 and/or electrical components 816. In some instances, the controller 808 may serve as an interface between the robotic device 800 and another computing device. Furthermore, the controller 808 may serve as an interface between the robotic device 800 and a user(s). The controller 808 may include various components for communicating with the robotic device 800, including one or more joysticks or buttons, among other features. The controller 808 may perform other operations for the robotic device 800 as well. Other examples of controllers may exist as well.

Additionally, the robotic device 800 may include one or more sensor(s) 810 such as image sensors, force sensors, proximity sensors, motion sensors, load sensors, position sensors, touch sensors, depth sensors, ultrasonic range sensors, and/or infrared sensors, or combinations thereof, among other possibilities. The sensor(s) 810 may, for example, correspond to the sensors 132 of the robot 100 described above. The sensor(s) 810 may provide sensor data to the processor(s) 802 to allow for appropriate interaction of the robotic device 800 with the environment as well as monitoring of operation of the systems of the robotic device 800. The sensor data may be used in evaluation of various factors for activation and deactivation of mechanical components 814 and electrical components 816 by controller 808 and/or a computing system of the robotic device 800.

The sensor(s) 810 may provide information indicative of the environment of the robotic device for the controller 808 and/or computing system to use to determine operations for the robotic device 800. For example, the sensor(s) 810 may capture data corresponding to the terrain of the environment or location of nearby objects, which may assist with environment recognition and navigation, etc. In an example configuration, the robotic device 800 may include a sensor system that may include a camera, RADAR, LIDAR, time-of-flight camera, global positioning system (GPS) transceiver, and/or other sensors for capturing information of the environment of the robotic device 800. The sensor(s) 810 may monitor the environment in real-time and detect obstacles, elements of the terrain, weather conditions, temperature, and/or other parameters of the environment for the robotic device 800.

Further, the robotic device 800 may include other sensor(s) 810 configured to receive information indicative of the state of the robotic device 800, including sensor(s) 810 that may monitor the state of the various components of the robotic device 800. The sensor(s) 810 may measure activity of systems of the robotic device 800 and receive information based on the operation of the various features of the robotic device 800, such as the operation of extendable legs, arms, or other mechanical and/or electrical features of the robotic device 800. The sensor data provided by the sensors may enable the computing system of the robotic device 800 to determine errors in operation as well as monitor overall functioning of components of the robotic device 800.

For example, the computing system may use sensor data to determine the stability of the robotic device 800 during operations as well as measurements related to power levels, communication activities, components that require repair, among other information. As an example configuration, the robotic device 800 may include gyroscope(s), accelerometer(s), and/or other possible sensors to provide sensor data relating to the state of operation of the robotic device. Further, sensor(s) 810 may also monitor the current state of a function, such as a gait, that the robotic device 800 may currently be operating. Additionally, the sensor(s) 810 may measure a distance between a given robotic leg of a robotic device and a center of mass of the robotic device. Other example uses for the sensor(s) 810 may exist as well.

Additionally, the robotic device 800 may also include one or more power source(s) 812 configured to supply power to various components of the robotic device 800. Among possible power systems, the robotic device 800 may include a hydraulic system, electrical system, batteries, and/or other types of power systems. As an example illustration, the robotic device 800 may include one or more batteries configured to provide power to components via a wired and/or wireless connection. Within examples, components of the mechanical components 814 and electrical components 816 may each connect to a different power source or may be powered by the same power source. Components of the robotic device 800 may connect to multiple power sources as well.

Within example configurations, any suitable type of power source may be used to power the robotic device 800, such as a gasoline and/or electric engine. Further, the power source(s) 812 may charge using various types of charging, such as wired connections to an outside power source, wireless charging, combustion, or other examples. Other configurations may also be possible. Additionally, the robotic device 800 may include a hydraulic system configured to provide power to the mechanical components 814 using fluid power. Components of the robotic device 800 may operate based on hydraulic fluid being transmitted throughout the hydraulic system to various hydraulic motors and hydraulic cylinders, for example. The hydraulic system of the robotic device 800 may transfer a large amount of power through small tubes, flexible hoses, or other links between components of the robotic device 800. Other power sources may be included within the robotic device 800.

Mechanical components 814 can represent hardware of the robotic device 800 that may enable the robotic device 800 to operate and perform physical functions. As a few examples, the robotic device 800 may include actuator(s), extendable leg(s) (“legs”), arm(s), wheel(s), one or multiple structured bodies for housing the computing system or other components, and/or other mechanical components. The mechanical components 814 may depend on the design of the robotic device 800 and may also be based on the functions and/or tasks the robotic device 800 may be configured to perform. As such, depending on the operation and functions of the robotic device 800, different mechanical components 814 may be available for the robotic device 800 to utilize. In some examples, the robotic device 800 may be configured to add and/or remove mechanical components 814, which may involve assistance from a user and/or other robotic device. For example, the robotic device 800 may be initially configured with four legs, but may be altered by a user or the robotic device 800 to remove two of the four legs to operate as a biped. Other examples of mechanical components 814 may be included.

The electrical components 816 may include various components capable of processing, transferring, providing electrical charge or electric signals, for example. Among possible examples, the electrical components 816 may include electrical wires, circuitry, and/or wireless communication transmitters and receivers to enable operations of the robotic device 800. The electrical components 816 may interwork with the mechanical components 814 to enable the robotic device 800 to perform various operations. The electrical components 816 may be configured to provide power from the power source(s) 812 to the various mechanical components 814, for example. Further, the robotic device 800 may include electric motors. Other examples of electrical components 816 may exist as well.

In some implementations, the robotic device 800 may also include communication link(s) 818 configured to send and/or receive information. The communication link(s) 818 may transmit data indicating the state of the various components of the robotic device 800. For example, information read in by sensor(s) 810 may be transmitted via the communication link(s) 818 to a separate device. Other diagnostic information indicating the integrity or health of the power source(s) 812, mechanical components 814, electrical components 816, processor(s) 802, data storage 804, and/or controller 808 may be transmitted via the communication link(s) 818 to an external communication device.

In some implementations, the robotic device 800 may receive information at the communication link(s) 818 that is processed by the processor(s) 802. The received information may indicate data that is accessible by the processor(s) 802 during execution of the program instructions 806, for example. Further, the received information may change aspects of the controller 808 that may affect the behavior of the mechanical components 814 or the electrical components 816. In some cases, the received information indicates a query requesting a particular piece of information (e.g., the operational state of one or more of the components of the robotic device 800), and the processor(s) 802 may subsequently transmit that particular piece of information back out the communication link(s) 818.

In some cases, the communication link(s) 818 include a wired connection. The robotic device 800 may include one or more ports to interface the communication link(s) 818 to an external device. The communication link(s) 818 may include, in addition to or alternatively to the wired connection, a wireless connection. Some example wireless connections may utilize a cellular connection, such as CDMA, EVDO, GSM/GPRS, or 4G telecommunication, such as WiMAX or LTE. Alternatively or in addition, the wireless connection may utilize a Wi-Fi connection to transmit data to a wireless local area network (WLAN). In some implementations, the wireless connection may also communicate over an infrared link, radio, Bluetooth, or a near-field communication (NFC) device.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-described functions. The one or more controllers can be implemented in numerous ways, such as with dedicated hardware or with one or more processors programmed using microcode or software to perform the functions recited above.

Having described several aspects of at least one embodiment of this technology, it is to be appreciated that various alterations, modifications, and improvements will readily occur to those skilled in the art.

Such alterations, modifications, and improvements are intended to be part of this disclosure, and are intended to be within the spirit and scope of the technology. Further, though advantages of the present technology are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present technology may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the present technology may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
controlling, by at least one application and based at least in part on a topological map, navigation of a robot through an environment, the topological map including at least a first waypoint, a second waypoint, and a first edge representing a first path between the first waypoint and the second waypoint;
determining, by the at least one application, that the topological map includes at least one feature that identifies a first service, the first service configured to control the robot to perform at least one operation; and
instructing, by the at least one application and based at least in part on the topological map including the at least one feature, the first service to perform the at least one operation as the robot travels along at least a portion of the first path.

2. The method of claim 1, further comprising:
determining a navigation route that includes edges and waypoints from the topological map; and
determining, by the at least one application and based at least in part on the navigation route, a path for the robot through the environment.

3. The method of claim 2, wherein determining the navigation route further comprises:
accessing a mission recording identifying a subset of the waypoints of the topological map at which the robot is to perform corresponding actions; and
generating, using the mission recording and the topological map, the navigation route to include at least the subset of the waypoints.

4. The method of claim 1, wherein determining that the topological map includes the at least one feature further comprises:
determining that the first edge is associated with an identifier of the first service.

5. The method of claim 4, wherein determining that the first edge is associated with the identifier of the first service further comprises:
determining that the first edge is annotated with the identifier.

6. The method of claim 4, wherein determining that the first edge is associated with the identifier of the first service further comprises:
determining that the first edge is included within a designated region on the topological map; and
determining that the designated region is associated with the identifier.

7. The method of claim 4, further comprising:
determining that the first edge is further associated with first data; and
sending the first data to the first service to enable the first service to perform the at least one operation using the first data.

8. The method of claim 1, further comprising:
receiving, by a user interface associated with a robot, one or more inputs instructing the robot to perform at least one operation when the robot travels within a designated portion of the environment; and
issuing one or more instructions to include the at least one feature in the topological map.

9. The method of claim 8, wherein issuing the one or more instructions further comprises:
issuing at least one first instruction to associate an identifier of the first service with the first edge,
wherein the at least one application is configured to instruct the first service to control the robot to perform the at least one operation in response to the at least one application determining that the identifier of the first service is associated with the first edge.

10. The method of claim 9, further comprising:
configuring the at least one first instruction to associate the identifier with the first edge at least in part by annotating the first edge with the identifier.

11. The method of claim 9, further comprising:
configuring the at least one first instruction to associate first data with the first edge,
wherein the at least one application is further configured to send the first data to the first service to enable the first service to perform the at least one operation using the first data.

12. The method of claim 9, wherein
receiving the one or more inputs further comprises receiving a first input when the robot is at a first location at which the robot is to begin performing the at least one operation of the first service, and
issuing the one or more instructions further comprises issuing a second instruction to generate the first waypoint based on the first input.

13. The method of claim 9, wherein
receiving the one or more inputs further comprises receiving a second input when the robot is at a second location at which the robot is to cease performing the at least one operation of the first service, and
issuing the one or more instructions further comprises issuing a third instruction to generate the second waypoint based on the second input.

14. The method of claim 9, further comprising:
configuring the at least one first instruction to associate the identifier with the first edge at least in part by associating the identifier with a region on the topological map, and associating the region with the first edge.

15. The method of claim 14, wherein receiving the one or more inputs further comprises receiving an input identifying the region on the topological map.

16. The method of claim 1, wherein:
the at least one application is executed on at least one first processor, and
the first service is executed on at least one second processor distinct from the at least one first processor.

17-25. (canceled)

26. A system, comprising:
at least one processor; and
at least one computer-readable medium encoded with instructions which, when executed by the at least one processor, cause the system to:
control, by at least one application and based at least in part on a topological map, navigation of a robot through an environment, the topological map including at least a first waypoint, a second waypoint, and a first edge representing a first path between the first waypoint and the second waypoint;
determine, by the at least one application, that the topological map includes at least one feature that identifies a first service, the first service configured to control the robot to perform at least one operation; and
instruct, by the at least one application and based at least in part on the topological map including the at least one feature, the first service to perform the at least one operation as the robot travels along at least a portion of the first path.

27. The system of claim 26, wherein the at least one computer-readable medium is further encoded with additional instructions which, when executed by the at least one processor, further cause the system to:
determine a navigation route that includes edges and waypoints from the topological map; and
determine, by the at least one application and based at least in part on the navigation route, a path for the robot through the environment.

28-75. (canceled)

76. A mobile robot, comprising:
a robot body;
one or more locomotion based structures, coupled to the body, the one or more locomotion based structures being configured to move the mobile robot about an environment;
at least one first processor; and
at least one first computer-readable medium encoded with instructions which, when executed by the at least one first processor, cause the mobile robot to:
control, by at least one application and based at least in part on a topological map, navigation of the mobile robot through the environment, the topological map including at least a first waypoint, a second waypoint, and a first edge representing a first path between the first waypoint and the second waypoint;
determine, by the at least one application, that the topological map includes at least one feature that identifies a first service, the first service configured to control the mobile robot to perform at least one operation; and
instruct, by the at least one application and based at least in part on the topological map including the at least one feature, the first service to perform the at least one operation as the mobile robot travels along at least a portion of the first path.

77. The mobile robot of claim 76, wherein the at least one first computer-readable medium is further encoded with additional instructions which, when executed by the at least one first processor, further cause the mobile robot to:
determine a navigation route that includes edges and waypoints from the topological map; and
determine, by the at least one application and based at least in part on the navigation route, a path for the mobile robot through the environment.

78-100. (canceled)
